(19) United States
(12) Patent Application Publication
(10) Pub. No.: US 2025/0190717 A1
(43) Pub. Date: Jun. 12, 2025

(54) METHOD PERFORMED BY AN ELECTRONIC DEVICE, ELECTRONIC DEVICE AND COMPUTER-READABLE STORAGE MEDIA

(71) Applicant: SAMSUNG ELECTRONICS CO., LTD., Suwon-si (KR)

(72) Inventors: Yimeng ZHUANG, Beijing (CN); Shuo HU, Beijing (CN); Song LIU, Beijing (CN)

(73) Assignee: SAMSUNG ELECTRONICS CO., LTD., Suwon-si (KR)

(21) Appl. No.: 19/057,240

(22) Filed: Feb. 19, 2025

Related U.S. Application Data
(63) Continuation of application No. PCT/KR2023/014882, filed on Sep. 26, 2023.

(30) Foreign Application Priority Data
Sep. 27, 2022 (CN) 202211186115.5
Jul. 17, 2023 (CN) 202310876069.X
Aug. 9, 2023 (CN) 202311001646.7

(51) Int. Cl. G06F 40/40; G06F 40/284; G06F 40/30; G06N 5/02

(52) U.S. Cl. CPC G06F 40/40; G06F 40/284; G06F 40/30; G06N 5/02

(57) ABSTRACT

A language model updating method, performed by an electronic device includes, acquiring a first training sequence including at least one of text used for training or a token sequence corresponding to the text used for training; extracting a first general knowledge representation of the first training sequence using a first language model; using a second language model to extract a second general knowledge representation of the first training sequence and determine a plurality of prediction results corresponding to the first training sequence; and updating the second language model based on the first general knowledge representation, the second general knowledge representation, and the plurality of prediction results, wherein each of the first general knowledge representation and the second general knowledge representation include at least one of language patterns or semantic relationships, extracted from the first training sequence.

### CROSS-REFERENCE TO RELATED APPLICATIONS

This application is a by-pass continuation application of International Application No. PCT/KR2023/014882, filed on Sep. 26, 2023, which is based on and claims priority to Chinese Patent Application No. 202211186115.5, filed with the China National Intellectual Property Administration on Sep. 27, 2022, Chinese Patent Application No. 202310876069.X, filed with the China National Intellectual Property Administration on Jul. 17, 2023, Chinese Patent Application No. 202311001646.7, filed with the China National Intellectual Property Administration on Aug. 9, 2023, the disclosures of which are incorporated by reference herein in their entireties.

### FIELD

The present disclosure belongs to a field for artificial intelligence, for example, relates to a method performed by an electronic device, the electronic device and a computer-readable storage medium.

### DESCRIPTION OF RELATED ART

A language model learns statistical rules and semantic representations of natural language through task-specific training. Pre-trained language models may be applied to other natural language processing tasks (which may be referred to as downstream tasks), for example, machine reading comprehension (e.g., Stanford Question Answering Dataset (SQUAD) task), text classification (e.g., Named Entity Recognition (NER)), relationship extraction (e.g., Multi-Genre Natural Language Inference (MGNLI)) and the like.

### SUMMARY

According to an aspect of the disclosure, a language model updating method, performed by an electronic device includes, acquiring a first training sequence including at least one of text used for training or a token sequence corresponding to the text used for training; extracting a first general knowledge representation of the first training sequence using a first language model; using a second language model to extract a second general knowledge representation of the first training sequence and determine a plurality of prediction results corresponding to the first training sequence; and updating the second language model based on the first general knowledge representation, the second general knowledge representation, and the plurality of prediction results, wherein each of the first general knowledge representation and the second general knowledge representation include at least one of language patterns or semantic relationships, extracted from the first training sequence.

The updating the second language model may include determining a first loss based on the first general knowledge representation and the second general knowledge representation; determining a second loss based on the plurality of prediction results; and updating the second language model based on the first loss and the second loss.

The extracting the first general knowledge representation of the first training sequence may include determining a first hidden state of the first training sequence using a first encoder in the first language model; and determining a first prediction probability for a first plurality of tokens in the first training sequence based on the first hidden state, wherein the first prediction probability is taken as the first general knowledge representation.

The using the second language model may include determining a second hidden state of the first training sequence using a second encoder in the second language model; and determining a second prediction probability for a first plurality of tokens in the first training sequence based on the second hidden state, wherein the second prediction probability is taken as the second general knowledge representation.

The language model updating method may further include obtaining a masked sequence for a second training sequence, wherein at least a portion of tokens of the second training sequence are masked in the masked sequence; and updating the first language model based on the second training sequence and the masked sequence.

The updating the first language model based on the second training sequence and the masked sequence may include determining a third hidden state of the masked sequence and a fourth hidden state of the second training sequence using a first encoder in the first language model; determining a third prediction probability for a second plurality of tokens in the masked sequence based on the third hidden state, determining a fourth prediction probability for a third plurality of tokens in the second training sequence based on the fourth hidden state; determining a third loss based on the third prediction probability; determining a fourth loss based on the fourth prediction probability; and updating the first language model based on the third loss and the fourth loss.

The determining the third loss based on the third prediction probability may include determining the third loss based on the third prediction probability for a fourth plurality of tokens in a second section and a plurality of real tokens corresponding to the fourth plurality of tokens in the second section. The determining the fourth loss based on the fourth prediction probability may include determining the fourth loss based on the fourth prediction probability for a fifth plurality of tokens in a third section and the third prediction probability for the fourth plurality of tokens in the second section, and wherein the second section indicates a sequence for the at least the portion of the tokens in which the at least the portion of the tokens are masked, and the third section indicates a non-masked sequence for the at least the portion of the tokens in which the at least the portion of the tokens are not masked.

The determining the third hidden state of the masked sequence and the fourth hidden state of the second training sequence using the first encoder in the first language model may include determining, based on the masked sequence and the second training sequence, a contextual mask matrix in which values of elements in a first column corresponding to a non-masked token are a first value, and a value of an element on a diagonal is the first value and values of remaining elements are a second value in a second column corresponding to a masked token, wherein the first value is 0, and the second value is greater than a predetermined value; and determining the third hidden state of the masked sequence and the fourth hidden state of the second training sequence using the first encoder in the first language model, based on the contextual mask matrix.

The language model updating method may further include outputting a user interface, via a display of the electronic device, including a setup interface for the second language model, wherein the setup interface may include at least one of an interface indicating whether self-updating is on; an interface for authorizing obtaining of the first training sequence; an interface for selecting the first training sequence; an interface for downloading the second language model; and an interface for setting a self-updating frequency.

The first training sequence may be related to user activity associated with a user of the electronic device, the user activity including at least one of a chat history of the user, an email history of the user, or a text history of the user.

The second language model may be a personalized language model configured to adapt to text associated with a user of the electronic device.

The language model updating method of claim 1 wherein the second language model may include at least one of a smart reply model for text call reply, short message reply, email reply, chat reply, and a machine translation model.

According to an aspect of the disclosure, an electronic device for updating a language model includes one or more processors; and memory storing instructions that, when executed by the one or more processors, cause the electronic device to acquire a first training sequence including at least one of text used for training or a token sequence corresponding to the text used for training; extract a first general knowledge representation of the first training sequence using a first language model; use a second language model to extract a second general knowledge representation of the first training sequence and determine a plurality of prediction results corresponding to the first training sequence; and update the second language model based on the first general knowledge representation, the second general knowledge representation, and the plurality of prediction results, wherein each of the first general knowledge representation and the second general knowledge representation may include at least one of language patterns or semantic relationships, extracted from the first training sequence.

The instructions, when executed by the one or more processors, may cause the electronic device to determine a first loss based on the first general knowledge representation and the second general knowledge representation; determine a second loss based on the plurality of prediction results; and update the second language model based on the first loss and the second loss.

The instructions, when executed by the one or more processors, may cause the electronic device to determine a first hidden state of the first training sequence using a first encoder in the first language model and determine a first prediction probability for a first plurality of tokens in the first training sequence based on the first hidden state, wherein the first prediction probability is taken as the first general knowledge representation.

The instructions, when executed by the one or more processors, may cause the electronic device to determine a second hidden state of the first training sequence using a second encoder in the second language model; and determine a second prediction probability for a first plurality of tokens in the first training sequence based on the second hidden state, wherein the second prediction probability is taken as the second general knowledge representation.

The instructions, when executed by the one or more processors, may cause the electronic device to obtain a masked sequence for a second training sequence, wherein at least a portion of tokens of the second training sequence are masked in the masked sequence; and update the first language model based on the second training sequence and the masked sequence.

The instructions, when executed by the one or more processors, may cause the electronic device to determine a third hidden state of the masked sequence and a fourth hidden state of the second training sequence using a first encoder in the first language model; determine a third prediction probability for a second plurality of tokens in the masked sequence based on the third hidden state; determine a fourth prediction probability for a third plurality of tokens in the second training sequence based on the fourth hidden state; determine a third loss based on the third prediction probability; determine a fourth loss based on the fourth prediction probability; and update the first language model based on the third loss and the fourth loss.

The instructions, when executed by the one or more processors, may cause the electronic device to determine the third loss based on the third prediction probability for a fourth plurality of tokens in a second section and a plurality of real tokens corresponding to the fourth plurality of tokens in the second section; and determine the fourth loss based on the fourth prediction probability for a fifth plurality of tokens in a third section and the third prediction probability for the fourth plurality of tokens in the second section, wherein the second section indicates a sequence for the at least the portion of the tokens in which the at least the portion of the tokens are masked, and the third section indicates a non-masked sequence for the at least the portion of the tokens in which the at least the portion of the tokens are not masked.

According to an aspect of the disclosure, a non-transitory computer-readable storage medium having instructions recorded thereon, that, when executed by one or more processors, causes the one or more processors to acquire a first training sequence including at least one of text used for training or a token sequence corresponding to the text used for training; extract a first general knowledge representation of the first training sequence using a first language model; use a second language model to extract a second general knowledge representation of the first training sequence; and determine a plurality of prediction results corresponding to the first training sequence; and update the second language model based on the first general knowledge representation, the second general knowledge representation, and the plurality of prediction results, wherein each of the first general knowledge representation and the second general knowledge representation may include at least one of language patterns or semantic relationships, extracted from the first training sequence.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1A is a schematic diagram illustrating a method for training general language model in the offline training phase;

FIG. 1B is a schematic diagram illustrating a method for training (or updating) a personalized language model based on an interpolation solution;

FIG. 1C is a schematic diagram illustrating a method for training (or updating) a personalized model based on a continued training solution;

FIG. 2 is a flowchart illustrating a method performed by an electronic device according to embodiments of the present disclosure;

FIG. 3 is a schematic diagram illustrating an example of obtaining a general knowledge representation of a training sequence using a general language model;

FIG. 4 is a schematic diagram illustrating an example of obtaining a general knowledge representation of a training sequence and prediction results for the training sequence using a personalized language model according to embodiments of the present disclosure;

FIG. 5 is a flowchart illustrating an example of updating a personalized language model according to embodiments of the present disclosure;

FIG. 6A is a schematic diagram illustrating pre-training of a masked language model according to example embodiments of the present disclosure;

FIG. 6B is a schematic diagram illustrating fine-tuning of a masked language model according to example embodiments of the present disclosure;

FIG. 7 is a schematic diagram illustrating an input for pre-training of a masked language model according to example embodiments of the present disclosure;

FIG. 8 is a diagram illustrating a structure of a neural machine translation model used in example embodiments of the present disclosure;

FIG. 9 is a schematic block diagram illustrating a training device for training a machine translation model according to example embodiments of the present disclosure;

FIG. 10 is a schematic diagram illustrating an input for pre-training of masked language model with self-distillation and an architecture of the masked language model with self-distillation according to example embodiments of the present disclosure;

FIG. 11 is a schematic diagram illustrating a patch-wise attention mask matrix according to example embodiments of the present disclosure;

FIG. 12A illustrates an example of a setup interface for a language model according to embodiments of the present disclosure;

FIG. 12B illustrates a diagram of an example of a pop-up window generated in response to a user turning on a language model self-updating function through a language model self-updating on/off option;

FIG. 12C illustrates a diagram of an example of a pop-up window generated in response to a user selecting a private data selection option;

FIG. 12D illustrates a schematic diagram of an example of a pop-up window generated in response to a user selecting a language model self-updating frequency option;

FIG. 13A illustrates an example of a text call smart reply model in the prior art;

FIG. 13B illustrates an example of a text call smart reply model according to embodiments of the present disclosure;

FIG. 14 is a flowchart illustrating a method for training a machine translation model according to example embodiments of the present disclosure; and

FIG. 15 is a schematic block diagram illustrating an electronic device according to example embodiments of the present disclosure;

### DETAILED DESCRIPTION

The embodiments described in the disclosure, and the configurations shown in the drawings, are only examples of embodiments, and various modifications may be made without departing from the scope and spirit of the disclosure.

In order to enable those ordinarily skilled in the art to better understand technical solutions of the present disclosure, the technical solutions in the embodiments of the present disclosure will be described clearly and completely in conjunction with the accompanying drawings below.

It should be noted that the terms “first”, “second”, and the like in the description and claims of the present disclosure and the above-described accompanying drawings are used to distinguish similar objects, and are not necessarily used to describe a particular order or sequence. It should be understood that the terms used in this manner may be interchanged, so that the embodiments of the present disclosure described herein can be implemented in an order other than those illustrated or described herein. The implementations described in the embodiments below do not represent all embodiments consistent with the present disclosure. Conversely, they are only examples of devices and methods consistent with some aspects of the present disclosure as detailed in the appended claims.

It is noted herein that “at least one of . . . ” that is present in the present disclosure means including three cases of “any one of . . . ”, “a combination of two or more of . . . ”, and “all of . . . ”. For example, “including at least one of A and B” includes three juxtaposed cases of: (1) including A; (2) including B; and (3) including both A and B.

For another example, “performing at least one of step 1 and step 2” means three juxtaposed cases of (a) performing step 1; (b) performing step 2; (c) performing step 1 and step 2.

In practice, personalized language models may be widely used to fit the user's language type, event information, or domain knowledge.

A personalized language model may be implemented through a simple (weak) language model learning user information, and however, this approach is unable to remember complex user events and knowledge. Furthermore, a personalized language model may be implemented by fine-tuning a complex (strong) language model based on user information, and however, this approach tends to forget general language knowledge (e.g., language patterns, statistical rules, grammar, knowledge, etc.).

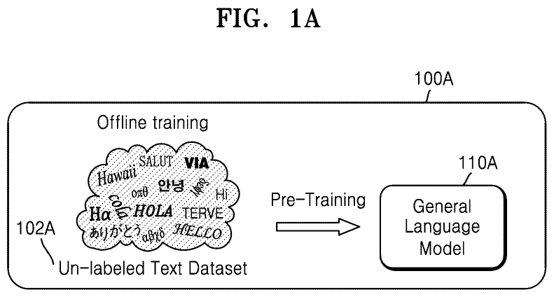

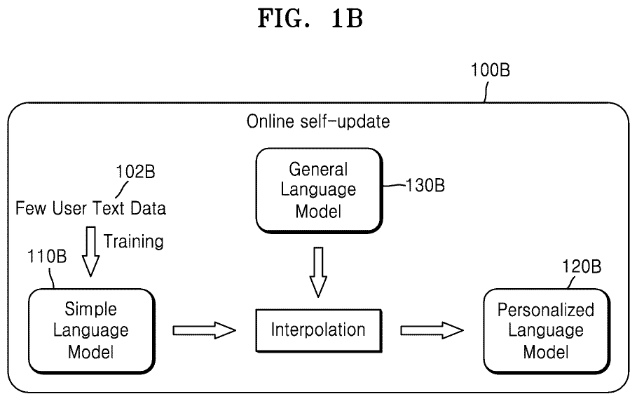

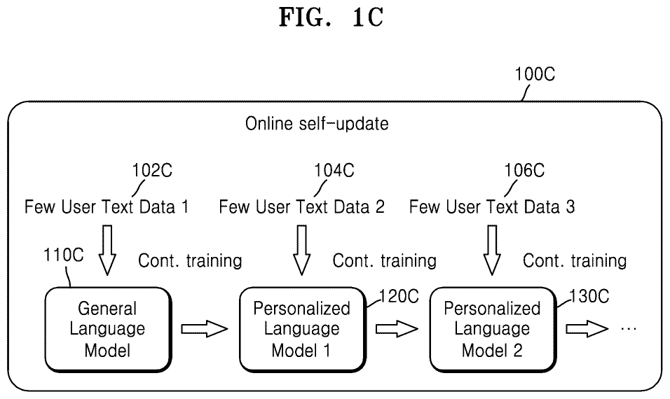

FIG. 1A is a schematic diagram illustrating a method for training general language model in the offline training phase.

Referring to FIG. 1A, in the offline training phase 100A, a large-scale unlabeled text dataset 102A may be fed into a general language model 110A so that general language knowledge is learned by the general language model 110A.

FIG. 1B is a schematic diagram illustrating a method for training (or updating) a personalized language model based on an interpolation solution.

Referring to FIG. 1B in the online self-updating phase 100B, a simple language model 110B may be trained based on a small amount of user text data 102B, and final output of a personalized language model 120B is computed by interpolating an output of the simple language model with an output of the general language model 130B. However, since the simple language model 110B lacks the ability of understanding complex data and interpolation weights are usually fixed, the performance of the personalized language model 120B obtained in this manner is low.

FIG. 1C is a schematic diagram illustrating a method for training (or updating) a personalized model based on a continued training solution.

Referring to FIG. 1C, in the online self-updating phase 100C, the general language model 110C is continued to be trained to adjust its statistical distributions to match user's data, so that an updated personalized language model 120C is obtained. However, as the personalization process proceeds, the general language knowledge learned in the pre-training phase is forgotten, which leads to low performance on long-term adaptation. For example, as the adaptation proceeds, a low-quality or even disfluent sentence is generated.

For example, an output of the general language model before updating is “And then I close the book”, and after updating, the output is “And I then close book” with a grammatical error.

In addition, a powerful language model may excessively adapt user data of which the amount is not enough, and excessively adapting on user data may largely destroy personalization performance of the language model.

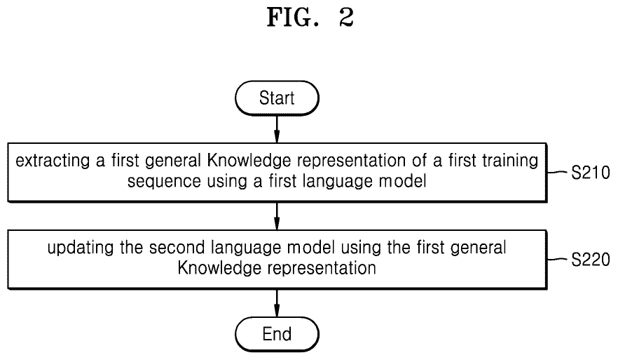

FIG. 2 is a flowchart illustrating a method performed by an electronic device according to embodiments of the present disclosure.

Referring to FIG. 2, at step S210, a first general knowledge representation of a first training sequence is extracted using a first language model.

It should be understood by those skilled in the art that a training sequence referred to herein may refer to, for example, text used for training or a token sequence corresponding to the text used for training.

According to an embodiment, the training sequence may be an arbitrary natural language text used for training.

According to an embodiment, the training sequence may be a word used for training.

According to an embodiment, the training sequence may be words used for training.

According to an embodiment, the training sequence may be a sentence used for training.

According to an embodiment, the training sequence may be multiple sentences used for training.

According to an embodiment, the training sequence may be a complete sentence used for training.

According to an embodiment, the first training sequence may be a text used for training or a token sequence corresponding to the text used for training.

According to an embodiment, the first training sequence may be an arbitrary natural language text used for training.

According to an embodiment, the first training sequence may be a word used for training.

According to an embodiment, the first training sequence may be words used for training.

According to an embodiment, the first training sequence may be a sentence used for training.

According to an embodiment, the first training sequence may be multiple sentences used for training.

According to an embodiment, the first training sequence may be a complete sentence used for training.

According to an embodiment, the first language model may be a pre-trained general language model. The general language model may extract a general knowledge representation that complies with general language rules based on user data.

According to an embodiment, the general knowledge representation may include language patterns, statistical rules or associations, syntactic structures or grammar, or semantic relationships or knowledge.

According to an embodiment, the first general knowledge representation may include language patterns, statistical rules or associations, syntactic structures or grammar, or semantic relationships or knowledge.

Those skilled in the art should understand that embodiments are not limited to this, and for example, the first language model may also be a personalized language model.

According to an embodiment, the extracting of the first general knowledge representation of the first training sequence using the first language model may include: determining a first hidden state of the first training sequence using a first encoder in the first language model; and determining a first prediction probability for each token in the first training sequence based on the first hidden state, wherein the first prediction probability for each token is taken as the first general knowledge representation.

According to an embodiment, the first encoder may be a Transformer encoder.

According to an embodiment, the first general knowledge representation may be computed by a first real token prediction head of the first language model.

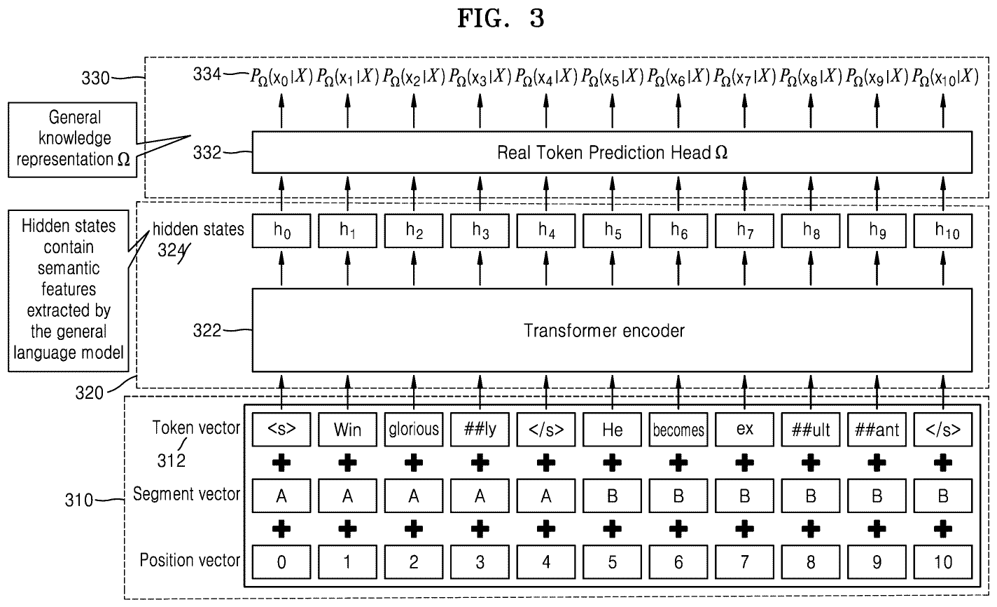

FIG. 3 is a schematic diagram illustrating an example of obtaining a general knowledge representation of a training sequence using a general language model.

Referring to FIG. 3, at operation 310, a training sequence (e.g., a user text) is fed into the general language model and a token vector 312 is obtained. An embedding table is looked up for each token, and a position embedding, a segment embedding, and a token embedding corresponding to each token are concatenated to obtain the token vector 312.

At operation 320, token vectors 312 are fed into a Transformer encoder 322 used for semantic feature extraction and hidden states 324 are obtained.

At operation 330, hidden states 324 are fed into a Real Token Prediction Head Ω 332 and prediction probabilities 334 for tokens of the user text are obtained by performing a computing for the hidden states 324 by the Real Token Prediction Head Ω 332.

Prediction probabilities 334 for tokens may be taken as a general knowledge representation because the prediction probabilities 334 represent language knowledge learnt at the offline phase and the self-updating phase.

According to an embodiment, the Real Token Prediction Head Ω 332 is a nonlinear fully connected layer, which may perform computing as follows:

$${P}_{Ω} ( {x}_{t} \vert X ) = \frac{exp ( {h}_{t}^{{Ω}^{T}} e ( {x}_{t} ) )}{{\sum }_{w ∈ V} exp ( {h}_{t}^{{θ}^{T}} e ( w ) )}$$

$$wherein$$

$${h}_{t}^{Ω} = gelu ( {h}_{t}^{T} {W}_{Ω} + {b}_{Ω} )$$

Wherein w_{Ω} and b_{Ω} denote learnable parameters, gelu denotes an activation function, e(w) denotes an embedding of a token w, V denotes a vocabulary, X denotes context, xₜ denotes the tth token in a sentence, and hₜ denotes a hidden state of a non-masked position t.

Since F_{Ω}(xₜ|x) 334 denotes extent to which the token xₜ matches its context X, it is knowledge about language patterns. In addition, existing language models may use a masked token prediction head, while the present disclosure uses a real token prediction head which may use single running in order to compute probabilities 334 for all tokens and thus is more efficient.

Returning to FIG. 2, at step S220, a second language model is updated using the first general knowledge representation.

According to an embodiment, the second language model may be a user personalized language model or a general language model.

According to an embodiment, the first language model and the second language model may be different personalized language models.

According to an embodiment, the first language model may be a general language model and the second language model may be a personalized language model.

According to an embodiment, the second language model may be a machine translation model.

According to an embodiment, the updating of the second language model using the first general knowledge representation may include: extracting a second general knowledge representation of the first training sequence and determining prediction results corresponding to the first training sequence, using the second language model; and updating the second language model based on the first general knowledge representation, the second general knowledge representation and the prediction results.

According to an embodiment, the second general knowledge representation may include language patterns, statistical rules, grammar, or knowledge.

It should be understood by those skilled in the art that the prediction results corresponding to the first training sequence may refer to a next token prediction (NTP) for the first training sequence.

According to an embodiment, the extracting of the second general knowledge representation of the first training sequence using the second language model may include: determining a second hidden state of the first training sequence using a second encoder in the second language model; and determining a second prediction probability for each token in the first training sequence based on the second hidden state, wherein the second prediction probability for each token is taken as the second general knowledge representation.

According to an embodiment, the second encoder may be a Transformer encoder.

According to an embodiment, the updating of the second language model based on the first general knowledge representation, the second general knowledge representation and the prediction results may include: determining a first loss based on the first general knowledge representation and the second general knowledge representation; determining a second loss based on the prediction results; and updating the second language model based on the first loss and the second loss.

According to an embodiment, the second prediction probability is calculated by a second real token prediction head of the second language model, wherein the first real token prediction head has the same structure as the second real token prediction head.

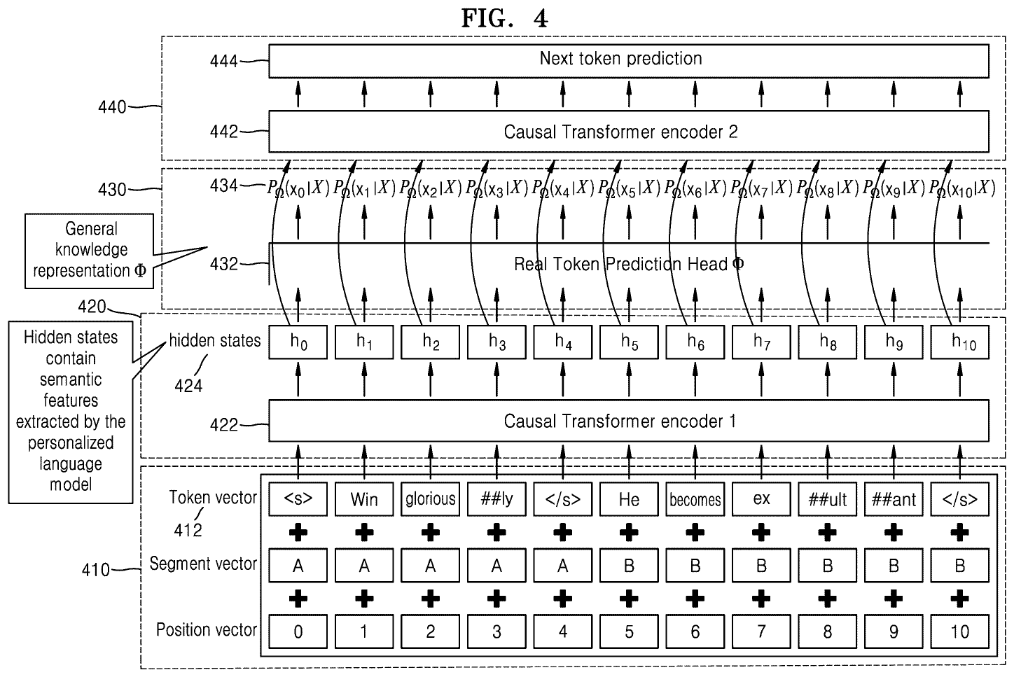

FIG. 4 is a schematic diagram illustrating an example of obtaining a general knowledge representation and prediction results (e.g., next token prediction) of a training sequence using a personalized language model according to embodiments of the present disclosure.

Referring to FIG. 4, at operation 410, a training sequence (e.g., user text data) is fed into the personalized language model and a token vector 412 is obtained. An embedding table is looked up for each token, and a position embedding, a segment embedding, and a token embedding corresponding to each token are concatenated to obtain the token vector 412.

At operation 420, token vectors 412 are fed into a Causal Transformer Encoder 1 422 used for semantic feature extraction, and hidden states 424 is obtained.

At operation 430, hidden states 424 are fed into a Real Token Prediction Head Φ 432 and prediction probabilities 434 for tokens of the user text are obtained by performing a computing for the hidden states 424 by the Real Token Prediction Head Φ 432. The prediction probabilities 434 may be taken as a general knowledge representation of the user text extracted by the personalized language model.

According to an embodiment, the real token prediction head Φ 432 may have the same structure as the real token prediction head Ω 332, but have trainable parameters different from that of real token prediction head Ω 332.

At operation 440, hidden states 424 from Causal Transformer encoder 1 422 are fed into a Causal Transformer encoder 2 442 to obtain a next token prediction 444.

As can be seen in FIG. 4, calculating prediction probabilities 434 for the tokens using the hidden states 424 from Causal Transformer encoder 1 422 does not corrupt original processing for the next token prediction 444.

According to an embodiment, the first loss may be used to assess an interval between the first general knowledge representation and the second general knowledge representation, and the second loss may be used to assess accuracy of the prediction results (e.g., the next token prediction).

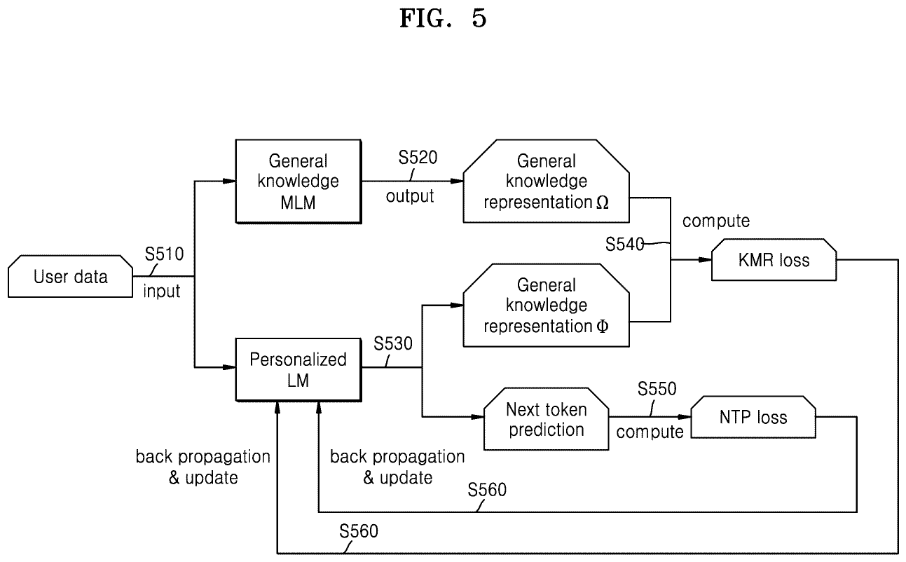

FIG. 5 is a flowchart illustrating an example of updating a personalized language model according to embodiments of the present disclosure. Referring to FIG. 5, at operation 510, a training sequence (e.g., user data or user text) is fed into a general language model (e.g., a pre-trained general knowledge masked language model) and a personalized language model, respectively.

At operation 520, the general language model outputs a general knowledge representation Ω in a form of prediction probabilities for tokens of the user data.

At operation 530, the personalized language model outputs the general knowledge representation Φ in a form of prediction probabilities for tokens of the user data and a next token prediction (NTP).

At operation 540, a knowledge memory retention (KMR) loss is calculated based on the general knowledge representation Ω and the general knowledge representation Φ, wherein the KMR loss [symbol] _{KMR} may be calculated based on the following equation:

$${ℒ}_{KMR} = - {\sum }_{t} {\sum }_{w} {P}_{Ω} ( {x}_{t} = w \vert X ) log {P}_{Φ} ( {x}_{t} = w \vert X )$$

$$wherein$$

$$P ( {x}_{t} = w \vert X )$$

is a token probability indicating the extent to which the token xₜ=w matches its context X, and the subscripts Ω and Φ correspond to the general knowledge representation Ω and Φ, respectively.

At operation 550, the NTP loss for representing accuracy of the NTP is computed.

At operation 560, parameters of the personalized language model are updated based on the KMR loss and the NTP loss. For example, the personalized language model is updated by calculating the gradient of the personalized language model using a backpropagation algorithm for the KMR loss and the NTP loss.

The general knowledge representation Φ remains close to the general knowledge representation Ω of the general language model by optimizing the KMR loss, which may include forcing the personalized language model to remember the general language knowledge. For example, the updated second language model may be made to remember knowledge learnt in the method described herein by the first language model.

An outdated general knowledge representation Ω may mislead the personalized language model in the self-updating phase based on the KMR loss, and thus the general language model to may use training to correctly learn new general language knowledge, such as new catchwords, new concepts, and hot words in news. Updating the general language model offline may lead to repeated download of the general language model from a server to a user device, and thus the cost is high.

To facilitate refinement of the first language model, the first language model may further be updated based on a second training sequence (e.g., a user text).

According to an embodiment, the second training sequence (e.g., the user text) may be data within a user device.

According to an embodiment, the first training sequence and/or the second training sequence may be related to user activity associated with a user of the electronic device.

For example, the first training sequence and/or the second training sequence may be user's chat history, email history, text history, and the like. A user model updated using such data may be more compliant with user's preferences.

According to an embodiment, the second training sequence may be an arbitrary natural language text used for training.

According to an embodiment, the second training sequence may be a word used for training.

According to an embodiment, the second training sequence may be words used for training.

According to an embodiment, the second training sequence may be a sentence used for training.

According to an embodiment, the second training sequence may be multiple sentences used for training.

According to an embodiment, the second training sequence may be a complete sentence used for training.

According to an embodiment, the updating of the first language model based on the second training sequence (e.g., the user text) may include: obtaining a masked sequence for the second training sequence, wherein at least portion of tokens of the second training sequence are masked in the masked sequence; updating the first language model based on the second training sequence and the masked sequence.

According to an embodiment, the updating of the first language model based on the second training sequence and the masked sequence may include: determining a third hidden state of the masked sequence and a fourth hidden state of the second training sequence using a first encoder in the first language model; determining a third prediction probability for each token in the masked sequence based on the third hidden state, determining a fourth prediction probability for each token in the second training sequence based on the fourth hidden state; determining a third loss based on the third prediction probability; determining a fourth loss based on the fourth prediction probability; and updating the first language model based on the third loss and the fourth loss.

According to an embodiment, the determining of the third loss based on the third prediction probability may include: determining the third loss based on the third prediction probability for each token in a second section and a real token corresponding to each token in the second section, and wherein the determining of the fourth loss based on the fourth prediction probability may include: determining the fourth loss based on the fourth predicted probability for each token in a third section and the third prediction probability for each token in the second section, and wherein the second section indicates a sequence for the at least portion of the tokens in which the at least portion of the tokens are masked, and the third section indicates a non-masked sequence for the at least portion of the tokens in which the at least portion of the tokens are not masked.

According to an embodiment, the determining of the third hidden state of the masked sequence and the fourth hidden state of the second training sequence using the first encoder in the first language model may include: determining, based on the masked sequence and the second training sequence, a context mask matrix in which values of elements in a column corresponding to a non-masked token are a first value, and a value of an element on a diagonal is the first value and values of remaining elements are a second value in a column corresponding to a masked token, wherein the first value is 0, and the second value is greater than a predetermined value; determining the third hidden state of the masked sequence and the fourth hidden state of the second training sequence using the first encoder in the first language model, based on the context mask matrix.

How to train or update the first language model will be described in more detail below. For ease of description, hereinafter, the present disclosure is described by taking the first language model being a masked language model and the second language model being a machine translation model according to an embodiment.

Those skilled in the art should understand that the expression “train” may be used interchangeably with “update” herein.

The masked language model has become a landmark approach for transfer learning in natural language processing due to accuracy achieved in a variety of natural language processing tasks that exceeds those of previous approaches.

According to an embodiment, the transfer learning process of the masked language model is divided into two portions: pre-training and fine-tuning. In the pre-training of the masked language model, the masked language model learns contextually relevant semantic representations through a task in which a portion of words (or subwords) in an input text are masked and then the masked words (or subwords) may be predicted using a Transformer model. In downstream tasks, the training of a downstream task model is finished by fine-tuning model parameters using information learnt in the pre-training and information learnt in the downstream task.

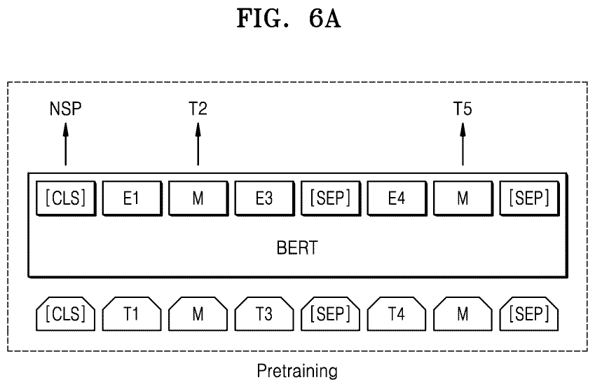

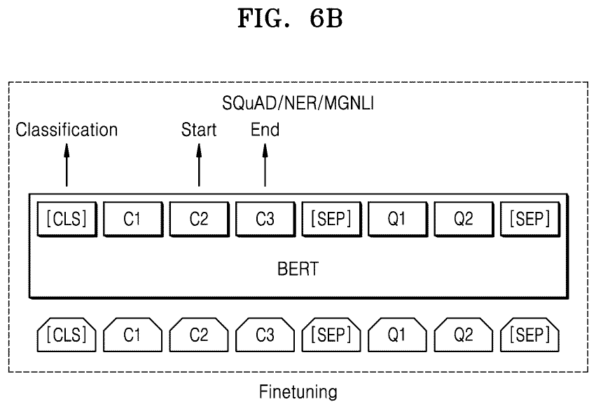

FIG. 6A is a schematic diagram illustrating pre-training of a masked language model according to example embodiments of the present disclosure.

For example, the input to the masked language model may be a training sequence, e.g., one text sentence or more text sentences, wherein each word in the text corresponds to a token.

For example, the transformer model may be BERT.

For example, a Transformer model is in the BERT box. The full name of BERT is Bidirectional Encoder Representation from Transformers which is a pre-trained language representation model. Inputs to the BERT are representations corresponding to respective tokens. The [CLS] and [September] are placeholders the [CLS] may be used to represent semantics of whole-sentence (e.g., a relationship between two sentences, a category of the two sentences, etc.), and the [September] may separate sentences. At the top is the model output for outputting predictions for the masked tokens (e.g., words, subwords). The NSP denotes a next sentence prediction. FIG. 6B is a schematic diagram illustrating fine-tuning of a masked language model according to example embodiments of the present disclosure.

For example, the transformer model may be BERT.

For example, The fine-tuning may vary depending on structures of different downstream tasks and FIG. 6B is a model structure for a machine reading comprehension task (e.g., SQUAD), however, it is not limited to this, and FIG. 6B may also be a model structure for NER or MGNLI, and the like.

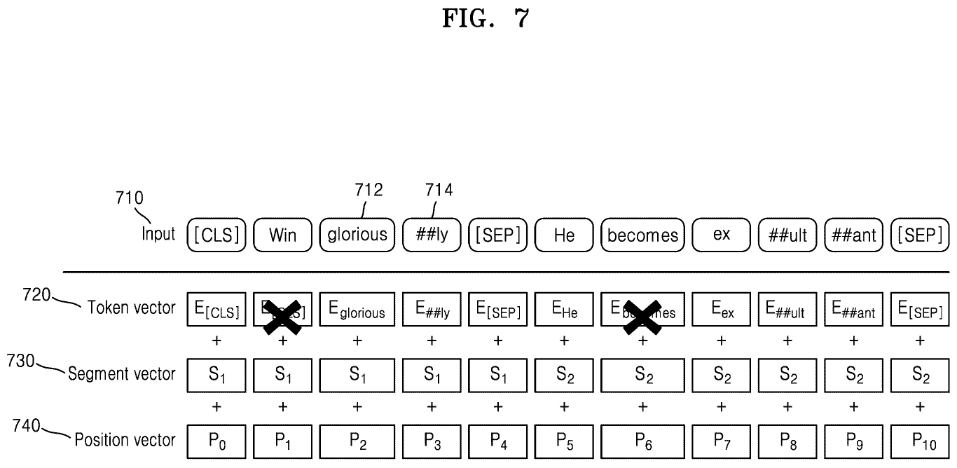

FIG. 7 is a schematic diagram illustrating an input for pre-training of a masked language model according to example embodiments of the present disclosure.

As illustrated in FIG. 7, an input text 710 is two sentences: Win gloriously and He becomes exultant. Since a token uses a subword (which is a smaller unit than a word), gloriously may be divided into subwords glorious 712 and ##ly 714. Each subword in the input text may be represented as a vector, which may consist of three portions. For example, the input text 710 is obtained by summing the three portions. One portion is a token vector (e.g., a token embedding 720): each subword/token obtains its corresponding token vector (e.g., a token embedding 720) by looking up a table. One portion is a segment vector (e.g., a segment embedding 730): the example here is two segments, the first sentence (Win gloriously) is one segment and is labelled as a vector S₁, and the second sentence (He becomes exultant) is another segment and is labelled as a vector S₂. One portion is a position vector (e.g., a position embedding 740): each subword may use a position vector (e.g., a position embedding 740) of a position corresponding to each subword in order. The “masked” of the masked language model is reflected by masking for token vectors (e.g., a token embedding 720), as shown by bold X in FIG. 7, wherein token vectors for a portion of the subwords are masked and replaced by a placeholder [MASK]. During the pre-training, the masked language model predicts the masked portion to recover the masked tokens.

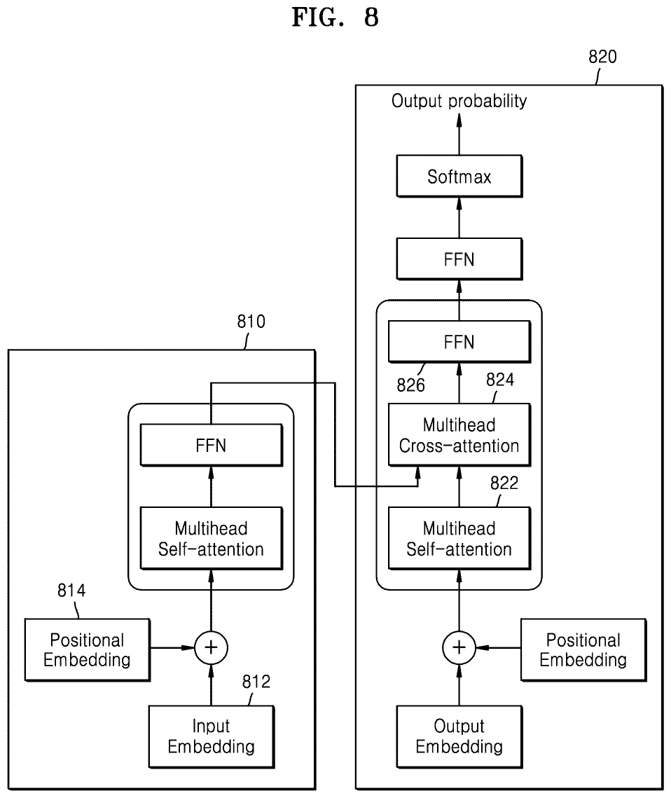

FIG. 8 is a schematic diagram of a structure of a Neural Machine Translation (NMT) model used in example embodiments of the present disclosure.

The left portion of FIG. 8 shows an encoding portion 810 of an encoder of the Neural Machine Translation model and the right portion of FIG. 8 shows a decoding portion 820. A source language sentence 812 (e.g., an English sentence) to be translated is input to the encoding portion 810, and a text sequence of the source language sentence 812 is firstly converted into token vectors by the encoding portion 810, and semantic features are extracted by a multi-head self-attention network in the encoding portion 810. The output of the encoding portion 810 is a target language sequence (e.g. a German sequence) that has been partially translated and a probability distribution for respective source language tokens. An input to the decoding portion 820 is the target language sequence that has been partially translated, and a prediction for a next word may be obtained by a multi-head self-attention network 822, a cross-attention network 824 and a fully connected network 826 in the decoding portion 820.

Those skilled in the art should understand that a probability distribution for tokens described herein may have the same meaning as a prediction probability for the tokens or have meaning similar to the prediction probability for the tokens.

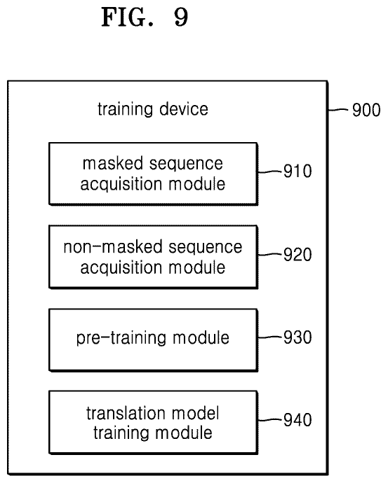

FIG. 9 is a schematic block diagram illustrating a training device 900 for training a machine translation model according to example embodiments of the present disclosure.

For example, the training device 900 may include a masked sequence acquisition module 910, a non-masked sequence acquisition module 920, a pre-training module 930, and a translation model training module 940. Here, the modules described above may be integrated into a smaller number of modules or may be divided into a larger number of modules to achieve identical functions. In addition, the above modules may include a software component or a hardware component, or a combination of the software component and the hardware component.

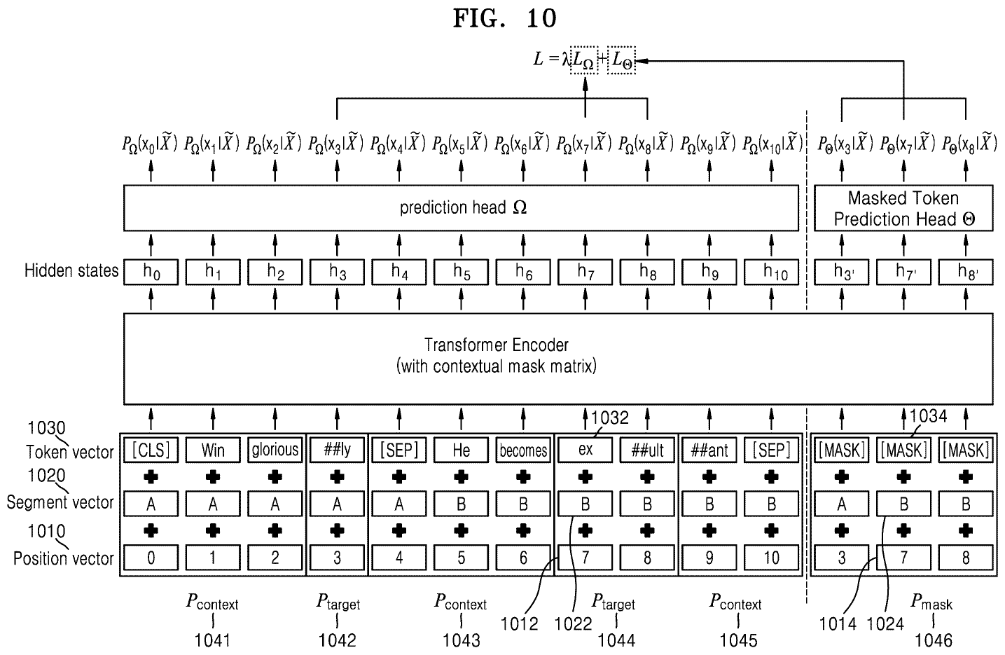

For example, the masked sequence acquisition module 910 may acquire a masked sequence of a training sequence (e.g., a training sentence), wherein at least portion of tokens in the training sequence are masked in the masked sequence (e.g., Win and becomes are masked, as shown in FIG. 9). The non-masked sequence acquisition module 920 may acquire a non-masked sequence in which the at least portion of the tokens are not masked for the at least portion of the tokens (as shown in FIG. 10 below). The pre-training module 930 may take the masked sequence and the non-masked sequence as a training set to pre-train a masked language model.

For example, the training sequence may be a training sentence.

FIG. 10 is a schematic diagram illustrating an input for pre-training of a masked language model with self-distillation and an architecture of the masked language model, according to example embodiments of the present disclosure.

For example, the present disclosure proposes pre-training of a masked language model with self-distillation to obtain a global distillation target for a neural machine translation model. A pre-trained masked language model may predict token probability distributions for respective masked positions on a vocabulary, and these token probabilities may indicate potential tokens that match the context. It may be assumed that these token probabilities contain language knowledge and the language knowledge may be transferred to a neural machine translation model. These token probabilities may be taken as distillation targets. However, the token probabilities are computed only for the masked positions, and only a small percentage (e.g., 15%) of tokens are masked in prior masking schemes, which may include that not a distillation target for each position of an input sequence can be obtained. In order to obtain globally defined distillation targets (e.g., distillation targets for respective positions), a self-distillation approach may be used, for example, token probabilities for non-masked positions are learnt from those for corresponding masked positions.

As illustrated in FIG. 10, an architecture of the masked language model with self-distillation is illustrated. An input sequence may be represented as S, which may be expressed either by a monolingual text S={X}={X₁, . . . , Xₙ} or by a pair of parallel sentences S={X, Y}={X₁, . . . , Xₙ, Y₁, . . . , Yₘ} in series. According to a random masking scheme, the input sequence may include non-masked positions and masked positions (e.g., 15%). In addition, according to example embodiments of the present disclosure, real tokens corresponding to the masked positions may be appended at the end of the sequence. In FIG. 10, for ease of viewing the input sequence (Win gloriously He becomes exultant), the real tokens (e.g., the P_{target} portion 1042, P_{target} portion 1044) corresponding to the masked positions is not shown at the end of the input sequence, while [MASK] tokens (e.g., the Pₘₐₛₖ portion 1046) for the masked positions are shown at the end of the input sequence. The model actually uses an input in which positions of the P_{target} 1042 and the P_{target} 1044 portion and the Pₘₐₛₖ 1046 portion of FIG. 10 are exchanged.

Thus, the entire input sequence may be divided into three portions: the context portion P_{context} 1041, P_{context} 1043, and P_{context} 1045 used as the known context; the masked portion Pₘₐₛₖ 1046 used for reconstructing a real token; and the target portion P_{target} 1042, and P_{target} 1044 tokens of which are real tokens corresponding to the masked portion, and which are assumed to be unknown during predicting token probabilities. A position vector (e.g., a position embedding), a segment vector (e.g, a language type embedding), and a [MASK] token vector (e.g., a [MASK] token embedding) corresponding to a token may be concatenated to form an input representation for the Pₘₐₛₖ 1046. For example, an input representation in the P_{target} 1042 and the P_{target} 1044 portion or the P_{context} 1041, the P_{context} 1043, and the P_{context} 1045 portion is in a form of the concatenation of a corresponding position vectors 1010 (e.g., position embeddings), corresponding segment vectors 1020 (e.g., language type embeddings), and corresponding token vectors 1030 (e.g., token embeddings).

For example, in addition to the masked sequence of the P_{context} 1041, the P_{context} 1043, and the P_{context} 1045 portion and the Pₘₐₛₖ 1046 portion shown in FIG. 10, an additional input token sequence (e.g., the P_{target} 1042, the P_{target} 1044 portion in FIG. 10) is added as an input for pre-training. The P_{target} 1042 portion is a non-masked sequence for the masked tokens, for example, the [MASK] may not be used to replace token vectors in the non-masked sequence, but, real token vectors may be used in the non-masked sequence. For example, as illustrated in FIG. 10, since the token “ex” is masked in the original sequence, an input vector corresponding to the token “ex” include a [MASK] token vector 1034, a segment vector 1024 and a position vector 1014. Accordingly, a real token vector for the “ex” is added in the additional input, and an input vector for the real token vector includes a token vector “ex” 1032, a segment vector 1022, and a position vector 1012. The added non-masked sequence may be spliced with the original masked sequence so that the spliced sequence is inputted into the masked language model.

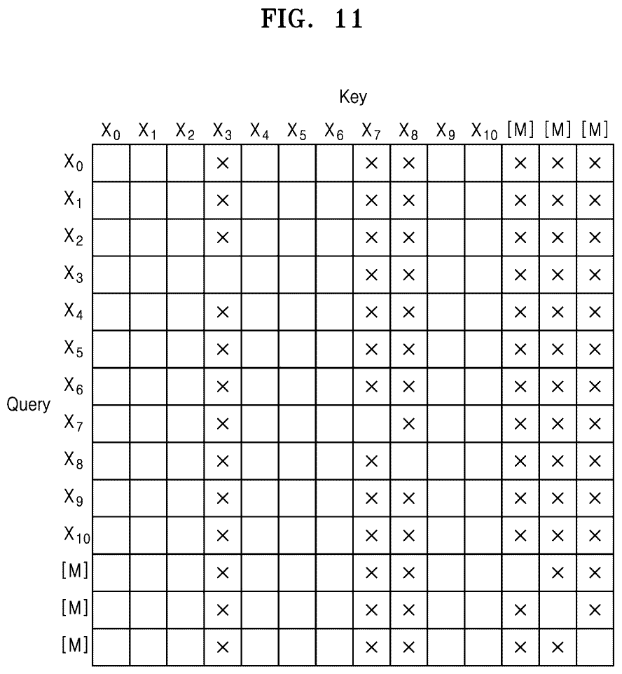

FIG. 11 is a schematic diagram illustrating a patch-wise attention mask matrix according to example embodiments of the present disclosure.

According to example embodiments of the present disclosure, the spliced sequence (e.g., a training set) described above may become the patch-wise attention mask matrix after being input into the masked language model. For example, the training set may be divided into 3 sections (or portions). A sequence for tokens other than the at least portion of the tokens (e.g., ##ly, ex and ##ult) in the training sequence (e.g., training sentence) is a first section (which may also be referred to as a context portion) of the training set, a sequence in which the at least portion of the tokens are masked for the at least portion of the tokens is the second section (which may also be referred to as a masked portion) of the training set, and a non-masked sequence is the third section (which may also be referred to as a target portion). Here, visible relations of tokens (e.g., known relations of tokens) in the different sections may be set to be different.

As illustrated in FIG. 11, for example, for the token x0 in row 1, it may see all tokens in the first section. In FIG. 11, squares in columns 1-3, 5-7, and 10-11, squares in row 4 column 4, row 8 column 8, and row 9 column 9, and squares in row 12 column 12, row 13 column 13, and row 14 column 14 indicate query tokens that make an attention to key tokens (e.g., query tokens that may see key tokens) in the context section, the target section, and the mask section, respectively, and squares with a symbol X indicate masked tokens.

In a reconstruction task for a masked token, a corresponding real token should remain unknown to a masked position. A hidden state of the masked position may be invisible to a corresponding target position in forward propagation, because a prediction probability for a masked position P_{θ}(tᵢ=Ω|\tilde{S}) is a learning target for a corresponding target position (for example, a leakage of supervision information is avoided). Since a backbone of the masked language model is a Transformer encoder, visibilities (being known/being unknown) of tokens are controlled by a context mask matrix. As illustrated in FIG. 11, the context mask matrix may control each token to see itself and tokens in the P_{context}. This may include that the context $ is set be S̅={ωₜ|ωₜϵP_{context}} in each of the three portions Pₘₐₛₖ, P_{target}, and P_{context}.

A Transformer model based on self-attention mechanism is used by the masked language model, wherein the masked language model uses an attention mask matrix, and the attention mask matrix in existing methods is set to make every two tokens visible to each other (e.g., all tokens in the entire masked sequence are mutually visible). In one or more embodiments, visible relationships of tokens may be modified so that respective tokens in the first section are mutually visible, each token in the second section is visible to itself and all tokens in the first section, and each token in the third section is visible to itself and all tokens in the first section. Flow of information between the second section and the third section may be avoided by modifying the visible relationships of the tokens.

Wherein the respective tokens in the first section being mutually visible may include that an attention probability for each of tokens in the first section is not set to zero (which may be understood as the attention probability not being forced to be set to zero) when performing attention computation for the tokens.

Each token in the second section being visible to itself and all tokens in the first section may include that an attention probability for each of tokens in the first section and the second section is not set to zero when performing attention computation for the tokens.

Each token in the third section being visible to itself and all tokens in the first section may include that an attention probability for each of tokens in the third section and the first section is not set to zero when performing attention computation for the tokens.

For example, a context mask matrix may be determined based on a masked sequence and a training sequence, and in the context mask matrix, values of elements in a column corresponding to a non-masked token are a first value, and a value of an element on a diagonal is the first value and values of remaining elements are a second value in a column corresponding to a masked token, wherein the first value is 0. According to an embodiment, the second value is greater than a preset value.

The masked language model may be pre-trained after the training set described above is input to the masked language model.

The pre-training module 930 may predict a probability distribution for each token xᵢ in the second section using the first section and the second section (which may be expressed as P(xᵢ|\tilde{X}), wherein \tilde{X} is a given masked sequence) based on the masked language model, obtain a loss L₁ based on the probability distribution for each token in the second section and a real token corresponding to each token in the second section. For example, with respect to the prediction for the second section, the objective L₁ loss function for the masked language model may be:

$${L}_{1} = \sum - log P ( {x}_{i} = {y}_{t} \vert \overline{X} )$$

wherein yᵢ indicates a real token in the ith position.

In addition, according to one or more embodiments, the pre-training module 930 may predict a probability distribution for each token in the third section using the first section and the third section based on the masked language model, obtain a loss L₂ based on the probability distribution for each token in the third section and the probability distribution for each token in the second section predicted above. For example, with respect to the prediction for the third section, the objective La loss function for the masked language model may be:

$${L}_{2} = \sum {\sum }_{w} - P ( {x}_{i} = w \vert \overline{X} ) log Q ( {x}_{i} = w \vert \overline{X} )$$

$$Wherein$$

$$Q ( {x}_{i} = w \vert \overline{X} ) = σ ( FFN ( {h}_{i} ) )$$

may be referred to as a bidirectional conditional probability for self-distillation, and may indicates a prediction of a probability distribution for each token position in the third section on the vocabulary under a given context (the first section) (for example, the probability distribution for each token in the third section). The σ may indicate a softmax function, w may indicate each token in the vocabulary, FFN may be a fully connected network, and hₜ may be a hidden vector for a token at the ith position of the third section at the last layer of the masked language model.

The significance of the objective function 12 is to use the probability distribution predicted for the second section as a prediction target for the third section. Since labels from data (for example, the real tokens corresponding to respective tokens in the second section) are used in L₁, there is noise, and the probability distribution predicted for the third section by the masked language model filters out some of the noise to some extent, noise of the prediction target for the third section is relatively less. The predicted probability distribution for the second section being used as the prediction target for the third section makes the probability distribution for each token in the third section approximate to that of each token in the second section, such a method may be referred to self-distillation.

For example, different loss functions may be applied to the masked portion (e.g., the second section) and the target portion (e.g., the third section). In the masked portion, the masked language model learns to reconstruct tokens that are masked. The masked language model pretends not to know a real token and predicts a potential token that matches the context at each position in the target portion. The learning makes the probability for the potential token approximate to a token reconstruction probability at the corresponding masked location. The reason is that the token reconstruction probability is the prediction probability for the potential token at the masked position.

For example, S̅={ωᵢ|ωᵢϵP_{context}} denotes a set of context tokens, S̅={ωᵢ|ωᵢϵP_{target}} denotes a set of target tokens, and tᵢ denotes a token at a location i. The reconstruction task for masked tokens defines an objective of the pre-training L_{θ} (for example, L₁ described above) as minimization of a negative log-likelihood of the target tokens as follows:

$${ℒ}_{Θ} = - log {P}_{Θ} ( \overline{S} \vert \overline{S} ) \approx - {\sum }_{{w}_{i} ∈ \overline{S}} log {P}_{Θ} ( {t}_{i} = {w}_{i} \vert \overline{S} )$$

Wherein the token reconstruction probability P_{θ} is defined in the masked portion and is computed by a prediction head θ.

$${P}_{Θ} ( {t}_{i} = {w}_{i} \vert \overline{S} ) = \frac{exp ( {h}_{i}^{{Θ}^{T}} e ( {w}_{i} ) )}{{\sum }_{w ∈ V} exp ( {h}_{i}^{{Θ}^{T}} e ( w ) )}$$

$${h}_{i}^{Θ} = gelu ( {h}_{i}^{′ T} {W}_{Θ} + {b}_{Θ} )$$

Wherein h′ᵢ may be used to denote a hidden state of the last layer of the Transformer encoder at a masked position i, w_{θ}ϵ [symbol] ^{D×X} and h_{θ}ϵ [symbol] ^{D} are learnable parameters of a prediction head Ω, D is a dimensionality, e(ω)ϵ [symbol] ^{D} denotes an embedding of a token w, and V denotes a vocabulary.

Here, the probabilities for potential tokens may be learnt using a self-distillation method.

A loss [symbol] _{Ω} (e.g., L₂ described above) is defined by optimizing KL divergence between a probability distribution for token reconstruction and a probability distribution for a potential token.

Wherein the probability for a potential token P_{Ω} is defined at a non-masked positions and is

$${ℒ}_{Ω} = - {\sum }_{i ∈ {P}_{target}} {\sum }_{w ∈ V} {P}_{Θ} ( {t}_{i} = w \vert \overline{S} ) log {P}_{Ω} ( {t}_{i} = w \vert \overline{S} )$$

computed by a prediction head Ω.

$${P}_{Ω} ( {t}_{i} = w \vert \overline{S} ) = \frac{exp ( {h}_{i}^{{Ω}^{T}} e ( w ) )}{{\sum }_{w ∈ V} exp ( {h}_{i}^{{Ω}^{T}} e ( w ) )}$$

$${h}_{i}^{Ω} = gelu ( {h}_{i}^{T} {W}_{Ω} + {b}_{Ω} )$$

Wherein hₜ denotes a hidden state of a non-masked position i.

During inferring, there are no masked positions in the input sequence S, and the probability for any potential token w at each position i may be computed as P_{Ω} (tᵢ=ω|S). As a result, these probabilities may be taken as global distillation targets for the neural machine translation model.

A final objective function of the masked language model may be set as L=λL₂+L₂ (e.g., a loss function [symbol] =λ [symbol] _{Ω}+ [symbol] _{θ} illustrated in FIG. 10), wherein λ is a fixed parameter. The pre-training module 930 may adjust model parameters of the masked language model based on the loss L₁ and the loss L₂ to obtain a pre-trained masked language model.

After completing the pre-training of the masked language model, the translation model training module 940 may train the machine translation model using the pre-trained masked language model described above.

According to an embodiment, the extracting of the first general knowledge representation of the first training sequence using the first language model may include: inputting a source sequence (e.g., a source sentence) and a target sequence (e.g., a target sentence) corresponding to the first training sequence into the first language model to obtain a fifth prediction probability for tokens of the source sequence (e.g., the source sentence) and a sixth prediction probability for tokens of the target sequence (e.g., the target sentence) by the first language model, wherein the fifth prediction probability and the sixth prediction probability are taken as the first general knowledge representation, the extracting of the second general knowledge representation of the first training sequence and determining of the prediction results corresponding to the first training sequence using the second language model may include: obtaining a seventh prediction probability for tokens of the source sequence (e.g., the source sentence) using an encoding portion of an encoder of the machine translation model, obtaining an eighth prediction probability for tokens of the target sequence (e.g., the target sentence) using a decoding portion of the encoder of the machine translation model, and determining prediction results for the source sequence (e.g., the source sentence) and the target sequence (e.g., the target sentence) using the encoder of the machine translation model, wherein the seventh prediction probability and the eighth prediction probability are taken as the second general knowledge representation, wherein the determining of the first loss based on the first general knowledge representation and the second general knowledge representation may comprise: obtaining a loss for the encoding portion of the encoder based on the fifth prediction probability and the seventh prediction probability and/or obtaining a loss for the decoding portion of the encoder based on the sixth prediction probability and the eighth prediction probability, wherein the determining of the second loss based the prediction results may include: determining the second loss based on the prediction results for the source sequence (e.g., the source sentence) and the target sequence (e.g., the target sentence), and wherein the updating of the second language model based on the first loss and the second loss may include: adjusting a parameter of the encoding portion based on the loss for the encoding portion and the second loss, and/or adjusting a parameter of the decoding portion based on the loss for the decoding portion and the second loss.

According to example embodiments of the present disclosure, when training the machine translation model, the translation model training module 940 may input a source sequence (e.g., a source sentence) and a target sequence (e.g., a target sentence) for training the machine translation model into the pre-trained masked language model to obtain probability distributions for tokens of the source sequence (e.g., the source sentence) and probability distributions for tokens of the target sequence (e.g., the target sentence) by the pre-trained masked language model.

In existing machine translation models, for example, only source language content (e.g., the source sentence) is visible to the encoding portion, while the present disclosure may transfer knowledge learnt by the bi-directional pre-trained masked language model to the machine translation model using knowledge distillation techniques. Here, the knowledge learnt by the masked language model is the probability distributions for all tokens of the source sequence (e.g., the source sentence) and the target sequence (e.g., the target sentence). In the encoding process, since the knowledge obtained by the pre-trained masked language model integrates the information of the source sequence (e.g., the source sentence) and the target sequence (e.g., the target sentence), the encoded representation matrix is more global, and compared to a traditional pre-training-fine-tuning model, the global distillation proposed in this disclosure solves the forgetting problem in fine-tuning to a certain extent.

Firstly, with respect to the encoding portion of the machine translation model, the translation model training module 940 may obtain a probability distribution for tokens of the source sequence (e.g., the source sentence) using the encoding portion of the machine translation model, obtain a loss for the encoding portion based on a probability distribution for the tokens of the source sequence (e.g., the source sentence) obtained by the masked language model and the probability distribution of the tokens of the source sequence (e.g., the source sentence) obtained by the encoding part, and adjust parameters of the encoding portion of the machine translation model based on the loss for the encoding part, wherein a representation matrix output by any one of a plurality of layers of the encoding portion is output after being updated. Probabilities for tokens predicted by the pre-trained masked language model with self-distillation are distilled to intermediate layers of the encoding portion of the neural machine translation model by optimizing the KL divergence, and the global distillation may be embodied in the following objective function:

$${L}_{Ω} = - {\sum }_{t} {\sum }_{w} {P}_{Ω} ( {x}_{t} = w \vert X , Y ) log {P}_{e} ( {x}_{t} = w \vert X )$$

$${P}_{e} = softmax ( {H}_{i} \cdot {E}^{T} )$$

Wherein the probability distribution s is a probability distribution predicted by the aforementioned pre-trained masked language model (for example, a distribution predicted by the global language model). X denotes an input source language sequence (e.g., a source sentence), and Y denotes a target language sequence (e.g., a target sentence). The xₜ denotes a position t of X. The ω is a token in a vocabulary V. Hᵢϵ [symbol] ^{|X|×D} denotes a representation matrix (e.g., a hidden state) of certain intermediate layer l in the encoder of the machine translation model. Lϵ [symbol] ^{V|×D} denotes a token vector matrix. The probability distribution matrix Pₑ denotes probability distributions on the vocabulary for tokens corresponding to respective token positions of the source sentence output by the intermediate layer and Pₑ(xₜ=ω|X) is a value of row t and column ω of the probability distribution matrix Pₑ.

According to an embodiment, the encoder of the machine translation model may also be used to determine prediction results for the source sentence and the target sentence (e.g., next token prediction), and the second loss (e.g., an NTP loss) is determined based on the prediction results.

According to an embodiment, the adjusting of the parameters of the encoding portion of the machine translation model based on the loss for the encoding portion may include: adjusting the parameters of the encoding portion of the machine translation model based on the loss of the encoding portion and the second loss.

In addition, the probability distribution predicted for tokens may be added to the encoding portion by reencoding the token representation H:

$${H}_{i}^{′} = {P}_{e} \cdot E + {H}_{i}$$

H′ₗ is an updated representation matrix for the intermediate layer and is fed into a next layer of the encoding portion.

Thus, a representation matrix output by any one of layers of the encoding portion may be updated based on a first probability distribution obtained by the masked language model described above and the probability distribution for the tokens of the source sentence output by the any one layer. This objective function makes a probability distribution represented by an intermediate layer of the encoding portion approximate to a distribution predicted by a global language model. During distillation training, parameters of the masked language model are fixed, and only parameters of the encoding portion may be updated.

Next, for the decoding portion of the encoder of the machine translation model, under a framework of an autoregressive machine translation model, each token position for the decoding portion may see entire source language sequence and partial sequence before current token position of the target language sequence. In order to achieve global distillation, the global distillation of the decoding portion may be carried out in a similar way to the global distillation of the encoding portion. The translation model training module 940 may obtain a probability distribution for tokens of the target sentence using the decoding portion of the machine translation model, obtain the loss for the decoding portion based on a probability distribution for the tokens of the target sentence obtained through the masked language model and the probability distribution of the tokens of the target sentence obtained using decoding portion of the machine translation model, and adjust the parameters of the decoding portion of the machine translation model based on the loss for the decoding portion.

However, because the decoding portion translates text using an autoregressive approach in practice, for example, the next token can be translated only when the previous token has been translated, the translating cannot be performed in parallel. In the global distillation for the encoding portion, there are two matrix multiplications for the vocabulary vector V, which has excessive influence on decoding speed of the decoding portion. A more lightweight global distillation method may be used in the present disclosure. The objective function of the global distillation for the decoding portion is shown as follows:

$${ℒ}_{d} = - {\sum }_{t} {\sum }_{w} {P}_{Ω} ( {y}_{t} = w \vert X , Y ) log {P}_{d} ( {y}_{t} = w \vert X , {Y}_{< t} )$$

$${P}_{d} = softmax ( {H}_{i} \cdot {E}^{T} ) .$$

Wherein the probability distribution P_{Ω} is a probability distribution predicted by the aforementioned pre-trained masked language model (for example, the distribution predicted by the global language model), X denotes an input source language sequence, and Y denotes a target language sequence. H₁ is a representation matrix (a hidden state) of certain intermediate layer of the decoding portion, and H₂ is passed directly into the next layer of the decoding part. The yₜ denotes a position t of the target language sequence. The significance of this objective function is to make a probability distribution represented by an intermediate layer of the decoding portion approximate to a distribution predicted by the global language model. Since the improvement to the decoding portion of this disclosure only exists during distillation training and there is no modification or update to an input for the next layer of the intermediate layer of the decoding portion, the decoding portion still performs decoding in the original way during decoding and thus the decoding speed is not be affected.

According to an embodiment, the adjusting of the parameters of the encoding portion of the machine translation model based on the loss for the decoding portion may include: adjusting the parameters of the decoding portion of the machine translation model based on the loss for the decoding portion and the second loss.

In addition, for example, for a non-autoregressive machine translation model, the global distillation method is still applicable to the non-autoregressive machine translation. The encoding portion of the non-autoregressive machine translation model is the same as the encoding portion of the autoregressive machine translation model described above and uses an identical global distillation approach. However, since an input for the decoding portion in the non-autoregressive machine translation model is usually upsampled, for example, length of an input sequence for the decoding portion is not consistent with length of the target language sequence, the global distillation approach described above for the decoding portion of the autoregressive machine translation model is unable be used.

In this regard, a solution proposed by the present disclosure is that a representation matrix output by any one of layers of the decoding portion may be output after being transformed in a case that the decoding portion is a non-autoregressive decoding portion. Here, the representation matrix output by any one of the layers of the non-autoregressive decoding portion may be transformed using the token matrix E for the target sentence based on a multi-head attention network of the decoding portion. The token matrix E may include input vectors corresponding to respective tokens in the target sentence (e.g., target language sequence) each of which may include a token vector and a position vector.

The objective function of global distillation for the non-autoregressive decoding portion is shown as follows:

$${ℒ}_{d} = - {\sum }_{t} {\sum }_{w} {P}_{Ω} ( {y}_{t} = w \vert X , Y ) log {P}_{d} ( {y}_{t} = w \vert X , Y )$$

$${P}_{d} = softmax ( {H}_{i}^{′} \cdot {E}^{T} )$$

$${H}_{i}^{′} = MultiHeadAttention ( emb ( Y ) , {H}_{i} , {H}_{i} )$$

Wherein the probability distribution Pa is a probability distribution predicted by the aforementioned pre-trained masked language model for the source language sequence and the target language sequence, X denotes an input source language sequence, Y denotes a target language sequence, H is a representation matrix for certain intermediate layer of the non-autoregressive decoding portion, and E is the token matrix for the target language sequence. MultiHeadAttention denotes a multi-head attention network of the non-autoregressive decoding portion, and emb(Y) denotes the concatenation of a token vector and a position vector of the target language sequence Y. For example, the emb(Y)) is used to perform multi-head attention operation on the representation matrix (hidden state) H, for a certain intermediate layer l of the non-autoregressive decoding portion to obtain the transformed representation matrix H′ₗ, so that the length of H′ₗ is consistent with the length of the target language sequence. Thus, a global distillation operation similar to that of the autoregressive decoding portion described above may be performed to obtain a trained machine translation model.

According to an embodiment, a setup interface for the second language model may be provided to a user, wherein the setup interface may include at least one of an interface indicating whether self-updating is on; an interface for authorizing obtaining the first training sequence; an interface for selecting the first training sequence; an interface for downloading the second language model; and an interface for setting self-updating frequency.

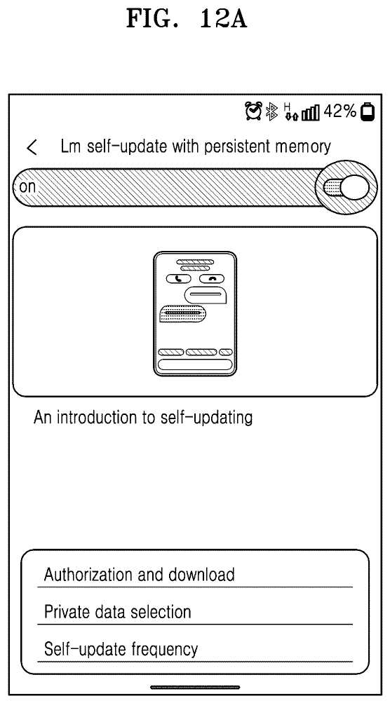

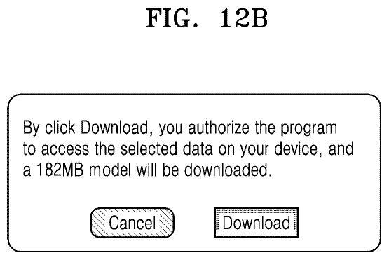

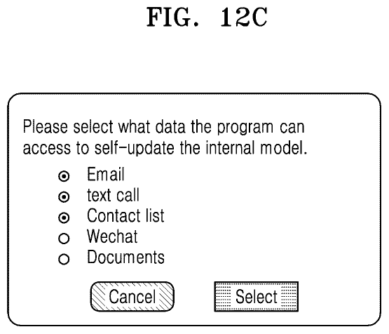

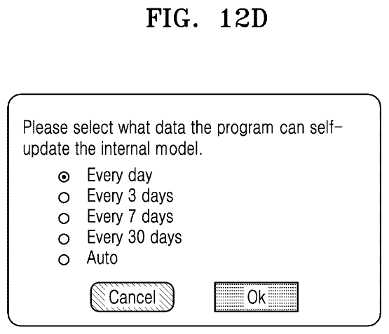

FIG. 12A illustrates an example of a setup interface for a language model (e.g., a second language model or a personalized language model) according to embodiments of the present disclosure.

Referring to FIG. 12A, the setup interface may include at least one of a language model self-updating on/off option, an authorization and download option, a private data selection option, a language model self-updating frequency option, and an introduction to the language model self-updating. It should be understood by those skilled in the art that the above information included in the setup interface is merely exemplary and does not limit the present disclosure.

According to an embodiment, the introduction to the language model self-updating can help a user understand what will happen after the language model self-updating function is turned on.

According to an embodiment, the introduction to the language model self-updating may include “by turning on the language model self-updating function option, you can get a better personalized text generation service. With the user's consent, we obtain text data for language model self-updating on the device. Self-learning is performed on the device side using an anti-forgetting self-updating algorithm with persistent memory, so that it has the ability of self-learning, long-term memory and cross dialogue understanding. Provide feedback suggestions for user conversations using the self-updated model. Please note that, your private data will only be used locally after this function is turned on”

According to an embodiment, the user may turn on or turn off the language model self-updating by selecting the language model self-updating on/off option.

According to an embodiment, in response to the user turning on the language model self-updating function via the language model self-updating on/off option, it can be, for example, visually displayed to the user, via an interface output to a display, that the language model self-updating function has been turned on.

FIG. 12B illustrates a diagram of an example pop-up window generated in response to the user turning on the language model self-updating function via the language model self-updating on/off option.

Referring to FIG. 12B, the user may download a general language model (e.g., a first language model) for updating the personalized language model via a download button in the pop-up window and is allowed to access to data selected on the device.

According to an embodiment, the window shown in FIG. 12B may be displayed only when the language model self-updating function is turned on for the first time.

FIG. 12C illustrates a diagram of an example pop-up window generated in response to a user selecting a private data selection option.

Referring to FIG. 12C, the user may select or modify data for updating the language model via the pop-up window.

FIG. 12D illustrates a diagram of an example of a pop-up window generated in response to a user selecting a language model self-updating frequency option.

Referring to FIG. 12D, the user may select or modify a frequency for updating the language model via the pop-up window. According to an embodiment, the language model may be updated at fixed intervals or when a preset condition is met. For example, the language model may be updated when a sufficient amount of data (e.g., 100 sentences) is accumulated.

The second language model according to embodiments of the present disclosure may be a smart reply model for text call reply, short message (SMS) reply, email reply, chat reply, and the like.

According to an embodiment, when a user receives a message from another person, a text call smart reply model (e.g., an AI call assistant) may provide a whole-sentence reply suggestion to reduce the user's input time.

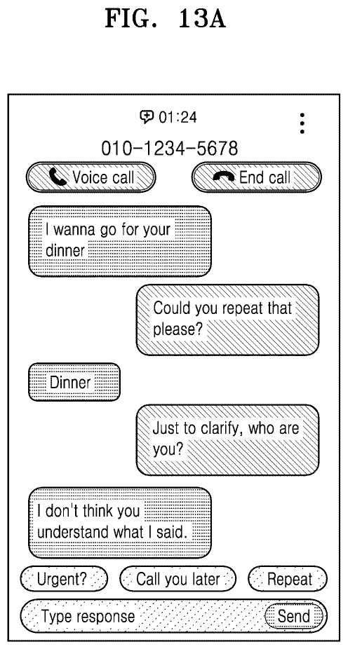

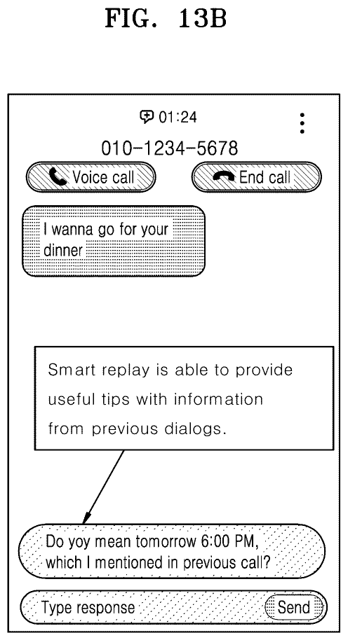

FIG. 13A illustrates an example of a text call smart reply model in the prior art.

Referring to FIG. 13A, the example of a text call smart reply model is capable of providing templated reply suggestions, which may have poor dialogue comprehension and poor personalization and thus may result in a poor experience for the user.

FIG. 13B illustrates an example of a text call smart reply model according to embodiments of the present disclosure.

Referring to FIG. 13B, the example of a text call smart reply model may use the user's conversation history, emails, texts, etc. to learn the user's language type, event information, and domain knowledge to persistently remember the user's personalized information, and thus the smart reply model may provide reply suggestions that are more in line with the user's expectations by remembering content from previous telephone conversations. The personalization model according to embodiments of the present disclosure may have the ability of self-learning, long-term memory and cross dialogue understanding via self-updating with persistent memory.

According to an embodiment, when a personalization model according to embodiments of the present disclosure is an SMS or email smart response model, it may predict the next input from the user in a manner with content consistence (e.g., the predicted input for current email is consistent with a previous email with a current subject) and type (e.g., the user's writing style) consistence.

According to an embodiment, when a personalization model according to embodiments of the present disclosure is a chat smart reply model, the model may provide reply suggestions in a useful and private manner. The whole replying process of the model may be finished locally, so that no data is uploaded to a cloud server, thereby protecting the privacy of the user.

According to example embodiments of the present disclosure, the method of the present disclosure involves an improvement to trainings of two models, e.g., the improvement to the pre-training of the first language model and the improvement to the training of the second language model.

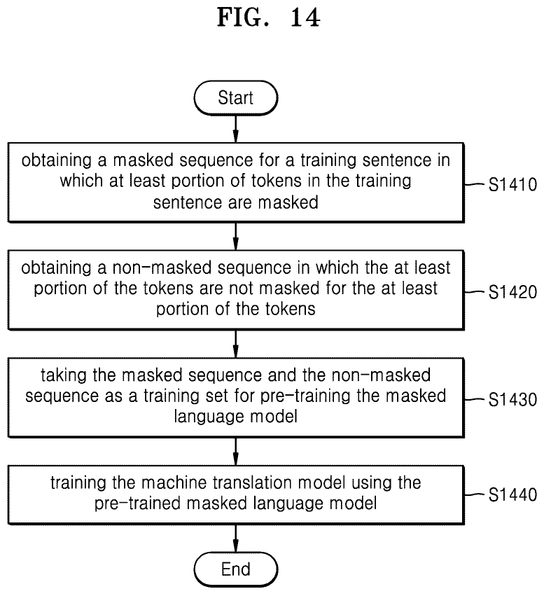

FIG. 14 is a flowchart illustrating a method for training a machine translation model according to example embodiments of the present disclosure.

At step 1410, a masked sequence for a training sentence may be obtained. In the masked sequence, at least portion of tokens in the training sentence are masked.

At step 1420, a non-masked sequence in which the at least portion of the tokens are not masked for the at least portion of the tokens may be obtained.

At step 1430, the masked sequence and the non-masked sequence may be used as a training set to pre-train the masked language model.

At step 1440, the machine translation model may be trained using the pre-trained masked language model.

As a result, a machine translation model with improved translation accuracy rate may be obtained.

According to example embodiments of the present disclosure, a machine translation method is provided, the machine translation method may include: obtaining a source sentence to be translated; and inputting the source sentence into the machine translation model trained by the method described above to obtain a target sentence corresponding to the source sentence.

TABLE 1

| model | accuracy rate |
|---|---|
| traditional machine translation | 27.4 |
| model | |
| machine translation model of the | 28.2 |
| present disclosure | |

Table 1 above shows experimental results using the existing English-German translation dataset WMT14. The English portion of the dataset is input into the machine translation model as the source sentences to be translated to obtain the target sentences corresponding to the source sentences. As can be seen from Table 1, the machine translation method of the present disclosure greatly improves the translation accuracy rate. The result verifies the validity of the machine translation model trained by the method for training the machine translation model described above.

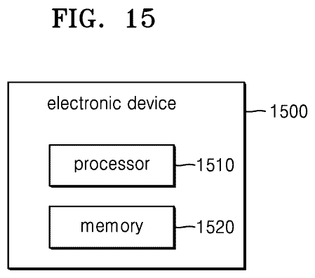

FIG. 15 is a schematic block diagram showing an electronic device 1500 according to an example embodiment of the present disclosure.

According to one or more embodiments, an electronic device 1500 may be provided, the electronic device 1500 may include: at least one processor 1510; at least one memory 1520 storing computer executable instructions, wherein the computer executable instructions, when executed by the at least one processor 1510, cause the at least one processor 1510 to perform the method performed by the electronic device according to one or more embodiments.

At least one of the plurality of modules described above may be implemented by an artificial intelligence (AI) model. Functions associated with AI may be performed through a non-volatile memory, a volatile memory, and a processor.

The processor may include one or more processors. At this point, one or more processors may be general-purpose processors, such as a central processing unit (CPU), an application processor (AP), etc., a processor used only for graphics (such as a graphics processor (GPU), a vision processor (VPU), and/or an AI-specific processor (such as a neural processing unit (NPU)).

One or more processors control processing for input data according to a predefined operation rule or an artificial intelligence (AI) model stored in a non-volatile memory and a volatile memory. The predefined operating rule or the AI model may be provided through training or learning. Herein, the providing by learning means that a predefined operational rule or an AI model with desired properties is formed by applying a learning algorithm to a plurality of sets of learning data. The learning may be performed within the device itself that performs AI according to the embodiment, and/or may be implemented through a separate server/device/system.

The learning algorithm is a method that trains a predetermined target device (for example, a robot) using a plurality of pieces of learning data to cause, allow, or control the target device to make a determination or prediction. Examples of the learning algorithm include but are not limited to supervised learning, unsupervised learning, semi-supervised learning, or reinforcement learning.

According to the present disclosure, in a method for training a machine translation model, a well-trained machine translation model may be obtained by taking source sequences and target sequences as input data for the machine translation model.

The AI model may be obtained by training. Herein, “obtained by training” means that an AI model with a plurality of pieces of training data is trained by a training algorithm to obtain a predefined operation rule or AI model configured to perform the desired feature (or purpose).

According to an embodiment, an AI model may include a plurality of neural network layers. Each of the plurality of neural network layers includes a plurality of weight values, and calculation for the neural network is performed by a calculation between calculation results of the previous layer and the plurality of weight values. Examples of the neural network include, but are not limited to, convolutional neural networks (CNNs), deep neural networks (DNNs), recurrent neural networks (RNNs), Restricted Boltzmann machines (RBMs), deep confidence networks (DBNs), bidirectional recurrent deep neural networks (BRDNNs), generative adversarial networks (GANs), and deep Q networks.

According to an embodiment of the present disclosure, there may be provided a computer readable storage medium storing computer programs thereon, wherein the computer programs, when executed, implement the method performed by the electronic device. Examples of the computer-readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, Hard Disk Drive (HDD), Solid State Drive (SSD), card storage (such as, multimedia cards, secure digital (SD) cards or extreme speed digital (XD) cards), magnetic tapes, floppy disks, magneto-optical data storage device, optical data storage device, hard disk, solid state disk, and any other devices that are configured to store computer programs and any associated data, data files and data structures in a non-transitory manner, and provide the computer programs and any associated data, data files and data structures to the processor or computer, so that the processor or computer may execute the computer programs. The instructions or computer programs in the above-mentioned computer-readable storage mediums may run in an environment deployed in a computer apparatus such as a client, a host, an agent device, a server, or the like. In addition, in one example, the computer programs and any associated data, data files and data structures are distributed on networked computer systems, so that the computer programs and any associated data, data files and data structures are stored, accessed, and executed in a distributed manner through one or more processors or computers.

Those skilled in the art may conceive of other embodiments after considering the description disclosed herein. The scope of the disclosure includes any modifications, uses, or adaptive changes of the present disclosure. These modifications, uses, or adaptive changes follow the scope of the present disclosure and include common knowledge or customary technical means in the technical field. The description and the embodiments are only regarded as exemplary, and the true scope and spirit of the present disclosure are defined by the claims.

It should be understood that the present disclosure is not limited to the structures that have already been described above and shown in the attached drawings, and that various modifications and changes may be made without deviating from its scope.

According to one or more embodiments, a method performed by an electronic device may include extracting a first general knowledge representation of a first training sequence using a first language model.

According to one or more embodiments, the method may include updating a second language model using the first general knowledge representation.

According to one or more embodiments, the method may include extracting a second general knowledge representation of the first training sequence and determining prediction results corresponding to the first training sequence, using the second language model.

According to one or more embodiments, the method may include updating the second language model based on the first general knowledge representation, the second general knowledge representation and the prediction results.

According to one or more embodiments, the method may include determining a first loss based on the first general knowledge representation and the second general knowledge representation.

According to one or more embodiments, the method may include determining a second loss based on the prediction results.

According to one or more embodiments, the method may include updating the second language model based on the first loss and the second loss.

According to one or more embodiments, the method may include determining a first hidden state of the first training sequence using a first encoder in the first language model.

According to one or more embodiments, the method may include determining a first prediction probability for each token in the first training sequence based on the first hidden state, wherein the first prediction probability for each token is taken as the first general knowledge representation.

According to one or more embodiments, the method may include determining a second hidden state of the first training sequence using a second encoder in the second language model.

According to one or more embodiments, the method may include determining a second prediction probability for each token in the first training sequence based on the second hidden state, wherein the second prediction probability for each token is taken as the second general knowledge representation.

According to one or more embodiments, at least one of the first encoder and the second encoder may be a Transformer encoder.

According to one or more embodiments, the method may include obtaining a masked sequence for a second training sequence, wherein at least portion of tokens of the second training sequence is masked in the masked sequence.

According to one or more embodiments, the method may include updating the first language model based on the second training sequence and the masked sequence.

According to one or more embodiments, the method may include determining a third hidden state of the masked sequence and a fourth hidden state of the second training sequence using a first encoder in the first language model.

According to one or more embodiments, the method may include determining a third prediction probability for each token in the masked sequence based on the third hidden state.

According to one or more embodiments, the method may include determining a fourth prediction probability for each token in the second training sequence based on the fourth hidden state.

According to one or more embodiments, the method may include determining a third loss based on the third prediction probability.

According to one or more embodiments, the method may include determining a fourth loss based on the fourth prediction probability

According to one or more embodiments, the method may include updating the first language model based on the third loss and the fourth loss.

According to one or more embodiments, the method may include determining the third loss based on the third prediction probability for each token in a second section and a real token corresponding to each token in the second section.

According to one or more embodiments, the method may include determining the fourth loss based on the fourth predicted probability for each token in a third section and the third prediction probability for each token in the second section.

According to one or more embodiments, the second section may indicate a sequence for the at least portion of the tokens in which the at least portion of the tokens are masked, and the third section indicate a non-masked sequence for the at least portion of the tokens in which the at least portion of the tokens are not masked.

According to one or more embodiments, the method may include determining, based on the masked sequence and the second training sequence, a contextual mask matrix in which values of elements in a column corresponding to a non-masked token are a first value, and a value of an element on a diagonal is the first value and values of remaining elements are a second value in a column corresponding to a masked token, wherein the first value is 0, and the second value is greater than a predetermined value.

According to one or more embodiments, the method may include determining the third hidden state of the masked sequence and the fourth hidden state of the second training sequence using the first encoder in the first language model, based on the contextual mask matrix.

According to one or more embodiments, the method may include providing a user with a setup interface for the second language model, wherein the setup interface comprises indicating whether self-updating is on.

According to one or more embodiments, the method may include providing a user with a setup interface for the second language model, wherein the setup interface comprises authorizing obtaining the first training sequence.

According to one or more embodiments, the method may include providing a user with a setup interface for the second language model, wherein the setup interface comprises selecting the first training sequence.

According to one or more embodiments, the method may include providing a user with a setup interface for the second language model, wherein the setup interface comprises downloading the second language model.

According to one or more embodiments, the method may include providing a user with a setup interface for the second language model, wherein the setup interface comprises setting a self-updating frequency.

According to one or more embodiments, the first training sequence may be related to user activity associated with a user of the electronic device.

According to one or more embodiments, the second language model may be a personalized language model.

According to one or more embodiments, the method inputting a source sentence and a target sentence corresponding to the first training sequence into the first language model to obtain a fifth prediction probability for tokens of the source sentence and a sixth prediction probability for tokens of the target sentence by the first language model, wherein the fifth prediction probability and the sixth prediction probability are taken as the first general knowledge representation.

According to one or more embodiments, the method obtaining a seventh prediction probability for tokens of the source sentence using an encoding portion of an encoder of the machine translation model.

According to one or more embodiments, the method obtaining an eighth prediction probability for tokens of the target sentence using a decoding portion of the encoder of the machine translation model.

According to one or more embodiments, the method determining prediction results for the source sentence and the target sentence using the encoder of the machine translation model, wherein the seventh prediction probability and the eighth prediction probability are taken as the second general knowledge representation.

According to one or more embodiments, the method obtaining a loss for the encoding portion of the encoder based on the fifth prediction probability and the seventh prediction probability and/or obtaining a loss for the decoding portion of the encoder based on the sixth prediction probability and the eighth prediction probability.

According to one or more embodiments, the method adjusting a parameter of the encoding portion based on the loss for the encoding portion and the second loss, and/or adjusting a parameter of the decoding portion based on the loss for the decoding portion and the second loss.

According to one or more embodiments, a representation matrix output by any one of a plurality of layers of the encoding portion may be output after being updated.

According to one or more embodiments, the method the representation matrix output by the any one of the plurality of layers of the encoding portion may be updated based on the fifth prediction probability and a prediction probability for tokens of the source sentence output by the any one of the plurality of layers of the encoding portion.

According to one or more embodiments, in a case that the decoding portion may be a non-autoregressive decoding portion.

According to one or more embodiments, the representation matrix output by any one of a plurality of layers of the decoding portion may be output after being transformed. According to one or more embodiments, the representation matrix output by the any one of the plurality of layers of the decoding portion may be transformed using a token matrix for the target sentence based on a multi-head attention network of the decoding portion.

According to one or more embodiments, the token matrix may comprise input vectors corresponding to respective tokens in the target sentence each of which comprises a token vector and a position vector.

According to one or more embodiments, the second language model may be at least one of a smart reply model for text call reply, short message reply, email reply, chat reply and a machine translation model.

According to one or more embodiments, at least one processor is configured to extract a first general knowledge representation of a first training sequence using a first language model.

According to one or more embodiments, at least one processor is configured to update a second language model using the first general knowledge representation.

According to one or more embodiments, at least one processor is configured to extract a second general knowledge representation of the first training sequence and determining prediction results corresponding to the first training sequence, using the second language model.

According to one or more embodiments, at least one processor is configured to update the second language model based on the first general knowledge representation, the second general knowledge representation and the prediction results.

According to one or more embodiments, at least one processor is configured to determine a first loss based on the first general knowledge representation and the second general knowledge representation.

According to one or more embodiments, at least one processor is configured to determine a second loss based on the prediction results.

According to one or more embodiments, at least one processor is configured to update the second language model based on the first loss and the second loss.

According to one or more embodiments, at least one processor is configured to determine a first hidden state of the first training sequence using a first encoder in the first language model.

According to one or more embodiments, at least one processor is configured to determine a first prediction probability for each token in the first training sequence based on the first hidden state, wherein the first prediction probability for each token is taken as the first general knowledge representation.

According to one or more embodiments, at least one processor is configured to determine a second hidden state of the first training sequence using a second encoder in the second language model.

According to one or more embodiments, at least one processor is configured to determine a second prediction probability for each token in the first training sequence based on the second hidden state, wherein the second prediction probability for each token is taken as the second general knowledge representation.

According to one or more embodiments, at least one processor is configured to obtain a masked sequence for a second training sequence, wherein at least portion of tokens of the second training sequence is masked in the masked sequence.

According to one or more embodiments, at least one processor is configured to update the first language model based on the second training sequence and the masked sequence.

According to one or more embodiments, at least one processor is configured to determine a third hidden state of the masked sequence and a fourth hidden state of the second training sequence using a first encoder in the first language model.

According to one or more embodiments, at least one processor is configured to determine a third prediction probability for each token in the masked sequence based on the third hidden state.

According to one or more embodiments, at least one processor is configured to determine a fourth prediction probability for each token in the second training sequence based on the fourth hidden state.

According to one or more embodiments, at least one processor is configured to determine a third loss based on the third prediction probability.

According to one or more embodiments, at least one processor is configured to determine a fourth loss based on the fourth prediction probability.

According to one or more embodiments, at least one processor is configured to update the first language model based on the third loss and the fourth loss.

According to one or more embodiments, at least one processor is configured to determine the third loss based on the third prediction probability for each token in a second section and a real token corresponding to each token in the second section.

According to one or more embodiments, at least one processor is configured to determine the fourth loss based on the fourth predicted probability for each token in a third section and the third prediction probability for each token in the second section.

According to one or more embodiments, at least one processor is configured to determine, based on the masked sequence and the second training sequence, a contextual mask matrix in which values of elements in a column corresponding to a non-masked token are a first value, and a value of an element on a diagonal is the first value and values of remaining elements are a second value in a column corresponding to a masked token, wherein the first value is 0, and the second value is greater than a predetermined value.

According to one or more embodiments, at least one processor is configured to determine the third hidden state of the masked sequence and the fourth hidden state of the second training sequence using the first encoder in the first language model, based on the contextual mask matrix.

According to one or more embodiments, at least one processor is configured to provide a user with a setup interface for the second language model, wherein the setup interface comprises indicating whether self-updating is on.

According to one or more embodiments, at least one processor is configured to provide a user with a setup interface for the second language model, wherein the setup interface comprises authorizing obtaining the first training sequence.

According to one or more embodiments, at least one processor is configured to provide a user with a setup interface for the second language model, wherein the setup interface comprises selecting the first training sequence.

According to one or more embodiments, at least one processor is configured to provide a user with a setup interface for the second language model, wherein the setup interface comprises downloading the second language model.

According to one or more embodiments, at least one processor is configured to provide a user with a setup interface for the second language model, wherein the setup interface comprises setting a self-updating frequency.

According to one or more embodiments, a computer readable medium containing at least one instruction that, when executed, causes at least one processor of a device to perform operations corresponding to the method.

What is claimed is:

1. A language model updating method, performed by an electronic device, comprising:
acquiring a first training sequence comprising at least one of: text used for training or a token sequence corresponding to the text used for training;
extracting a first general knowledge representation of the first training sequence using a first language model;
using a second language model to:
extract a second general knowledge representation of the first training sequence, and
determine a plurality of prediction results corresponding to the first training sequence; and
updating the second language model based on the first general knowledge representation, the second general knowledge representation, and the plurality of prediction results,
wherein each of the first general knowledge representation and the second general knowledge representation comprise at least one of: language patterns or semantic relationships, extracted from the first training sequence.

2. The language model updating method of claim 1, wherein the updating the second language model comprises:
determining a first loss based on the first general knowledge representation and the second general knowledge representation;
determining a second loss based on the plurality of prediction results; and
updating the second language model based on the first loss and the second loss.

3. The language model updating method of claim 1, wherein the extracting the first general knowledge representation of the first training sequence comprises:
determining a first hidden state of the first training sequence using a first encoder in the first language model; and
determining a first prediction probability for a first plurality of tokens in the first training sequence based on the first hidden state, wherein the first prediction probability is taken as the first general knowledge representation.

4. The language model updating method of claim 1, wherein the using the second language model comprises:
determining a second hidden state of the first training sequence using a second encoder in the second language model; and
determining a second prediction probability for a first plurality of tokens in the first training sequence based on the second hidden state, wherein the second prediction probability is taken as the second general knowledge representation.

5. The language model updating method of claim 1, further comprising:
obtaining a masked sequence for a second training sequence, wherein at least a portion of tokens of the second training sequence are masked in the masked sequence; and
updating the first language model based on the second training sequence and the masked sequence.

6. The language model updating method of claim 5, wherein the updating the first language model based on the second training sequence and the masked sequence comprises:
determining a third hidden state of the masked sequence and a fourth hidden state of the second training sequence using a first encoder in the first language model;
determining a third prediction probability for a second plurality of tokens in the masked sequence based on the third hidden state,
determining a fourth prediction probability for a third plurality of tokens in the second training sequence based on the fourth hidden state;
determining a third loss based on the third prediction probability;
determining a fourth loss based on the fourth prediction probability; and
updating the first language model based on the third loss and the fourth loss.

7. The language model updating method of claim 6, wherein the determining the third loss based on the third prediction probability comprises:
determining the third loss based on the third prediction probability for a fourth plurality of tokens in a second section and a plurality of real tokens corresponding to the fourth plurality of tokens in the second section,
wherein the determining the fourth loss based on the fourth prediction probability comprises:
determining the fourth loss based on the fourth prediction probability for a fifth plurality of tokens in a third section and the third prediction probability for the fourth plurality of tokens in the second section, and
wherein the second section indicates a sequence for the at least the portion of the tokens in which the at least the portion of the tokens are masked, and the third section indicates a non-masked sequence for the at least the portion of the tokens in which the at least the portion of the tokens are not masked.

8. The language model updating method of claim 6, wherein the determining the third hidden state of the masked sequence and the fourth hidden state of the second training sequence using the first encoder in the first language model comprises:
determining, based on the masked sequence and the second training sequence, a contextual mask matrix in which values of elements in a first column corresponding to a non-masked token are a first value, and a value of an element on a diagonal is the first value and values of remaining elements are a second value in a second column corresponding to a masked token, wherein the first value is 0, and the second value is greater than a predetermined value; and
determining the third hidden state of the masked sequence and the fourth hidden state of the second training sequence using the first encoder in the first language model, based on the contextual mask matrix.

9. The language model updating method of claim 1, further comprising:
outputting a user interface, via a display of the electronic device, comprising a setup interface for the second language model,
wherein the setup interface comprises at least one of: an interface indicating whether self-updating is on; an interface for authorizing obtaining of the first training sequence; an interface for selecting the first training sequence; an interface for downloading the second language model; and an interface for setting a self-updating frequency.

10. The language model updating method of claim 1, wherein the first training sequence is related to user activity associated with a user of the electronic device, the user activity comprising at least one of a chat history of the user, an email history of the user, or a text history of the user.

11. The language model updating method of claim 1, wherein the second language model is a personalized language model configured to adapt to text associated with a user of the electronic device.

12. The language model updating method of claim 1 wherein the second language model comprises at least one of: a smart reply model for text call reply, short message reply, email reply, chat reply, and a machine translation model.

13. An electronic device for updating a language model, the electronic device comprising:
one or more processors; and
memory storing instructions that, when executed by the one or more processors, cause the electronic device to:
acquire a first training sequence comprising at least one of: text used for training or a token sequence corresponding to the text used for training;
extract a first general knowledge representation of the first training sequence using a first language model;
use a second language model to:
extract a second general knowledge representation of the first training sequence, and
determine a plurality of prediction results corresponding to the first training sequence; and
update the second language model based on the first general knowledge representation, the second general knowledge representation, and the plurality of prediction results,
wherein each of the first general knowledge representation and the second general knowledge representation comprise at least one of: language patterns or semantic relationships, extracted from the first training sequence.

14. The electronic device of claim 13, wherein the instructions, when executed by the one or more processors, cause the electronic device to:
determine a first loss based on the first general knowledge representation and the second general knowledge representation;
determine a second loss based on the plurality of prediction results; and
update the second language model based on the first loss and the second loss.

15. The electronic device of claim 13, wherein the instructions, when executed by the one or more processors, cause the electronic device to:
determine a first hidden state of the first training sequence using a first encoder in the first language model; and
determine a first prediction probability for a first plurality of tokens in the first training sequence based on the first hidden state, wherein the first prediction probability is taken as the first general knowledge representation.

16. The electronic device of claim 13, wherein the instructions, when executed by the one or more processors, cause the electronic device to:
determine a second hidden state of the first training sequence using a second encoder in the second language model; and
determine a second prediction probability for a first plurality of tokens in the first training sequence based on the second hidden state, wherein the second prediction probability is taken as the second general knowledge representation.

17. The electronic device of claim 13, wherein the instructions, when executed by the one or more processors, cause the electronic device to:
obtain a masked sequence for a second training sequence, wherein at least a portion of tokens of the second training sequence are masked in the masked sequence; and
update the first language model based on the second training sequence and the masked sequence.

18. The electronic device of claim 17, wherein the instructions, when executed by the one or more processors, cause the electronic device to:
determine a third hidden state of the masked sequence and a fourth hidden state of the second training sequence using a first encoder in the first language model;
determine a third prediction probability for a second plurality of tokens in the masked sequence based on the third hidden state;
determine a fourth prediction probability for a third plurality of tokens in the second training sequence based on the fourth hidden state;
determine a third loss based on the third prediction probability;
determine a fourth loss based on the fourth prediction probability; and
update the first language model based on the third loss and the fourth loss.

19. The electronic device of claim 18, wherein the instructions, when executed by the one or more processors, cause the electronic device to:
determine the third loss based on the third prediction probability for a fourth plurality of tokens in a second section and a plurality of real tokens corresponding to the fourth plurality of tokens in the second section; and
determine the fourth loss based on the fourth prediction probability for a fifth plurality of tokens in a third section and the third prediction probability for the fourth plurality of tokens in the second section,
wherein the second section indicates a sequence for the at least the portion of the tokens in which the at least the portion of the tokens are masked, and the third section indicates a non-masked sequence for the at least the portion of the tokens in which the at least the portion of the tokens are not masked.

20. A non-transitory computer-readable storage medium having instructions recorded thereon, that, when executed by one or more processors, cause the one or more processors to:
acquire a first training sequence comprising at least one of: text used for training or a token sequence corresponding to the text used for training;
extract a first general knowledge representation of the first training sequence using a first language model;
use a second language model to:
extract a second general knowledge representation of the first training sequence, and
determine a plurality of prediction results corresponding to the first training sequence; and
update the second language model based on the first general knowledge representation, the second general knowledge representation, and the plurality of prediction results,
wherein each of the first general knowledge representation and the second general knowledge representation comprise at least one of: language patterns or semantic relationships, extracted from the first training sequence.
